(19) United States
(12) Patent Application Publication
(10) Pub. No.: US 2025/0173175 A1
(43) Pub. Date: May 29, 2025

(54) METHODS AND APPARATUSES TO DEBUG A CONFIDENTIAL VIRTUAL MACHINE FOR A PROCESSOR IN PRODUCTION MODE

(71) Applicant: Intel Corporation, Santa Clara, CA (US)

(72) Inventors: Junyuan Wang, Shanghai (CN); Greg Thomas, Limerick (IE); John Whiteman, Portland, OR (US); Ned M. Smith, Beaverton, OR (US)

(21) Appl. No.: 18/868,680

(22) PCT Filed: Jul. 1, 2022
(86) PCT No.: PCT/CN2022/103294

§ 371 Date: Nov. 22, 2024

(51) Int. Cl. G06F 9/455

(52) U.S. Cl. CPC G06F 9/45558; G06F 2009/45591

(57) ABSTRACT

Techniques for debugging a confidential virtual machine for a processor in production mode are described. In certain examples, a hardware processor core is to implement: a trust domain manager to manage one or more hardware isolated virtual machines as a respective trust domain with a region of memory protected by a respective encryption key, and a virtual machine monitor that is not allowed access to the protected region of memory of the one or more hardware isolated virtual machines; and a memory management circuit coupled between the hardware processor core and the memory, wherein, in response to a hardware isolated virtual machine generating a memory dump file, the trust domain manager is to encrypt the memory dump file with a debug key that is different from any of the respective encryption key to generate an encrypted memory dump file, and store the encrypted memory dump file in a portion of the memory that is accessible by the virtual machine monitor.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, and exception handling, and external input and output (IO). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF DRAWINGS

Various examples in accordance with the present disclosure will be described with reference to the drawings, in which:

FIG. 1 illustrates a block diagram of a computer system including a plurality of cores having a trust domain manager, a memory management circuit, and a memory including storage for a data structure for virtual machine debug keys (VDKs) according to examples of the disclosure.

FIG. 2 illustrates a block diagram of a host including a trust domain manager and storage for a data structure for VDKs according to examples of the disclosure.

FIG. 3 illustrates a block diagram of a host, in production mode, including a trust domain manager that disallows a host virtual machine monitor (VMM) from accessing (e.g., reading) a guest virtual machine's (e.g., trust domain's) private data out of the guest virtual machine's (e.g., trust domain's) memory space according to examples of the disclosure.

FIG. 4 illustrates a block diagram of a host including a trust domain manager that utilizes one or more VDKs to allow a host virtual machine monitor (VMM) to access (e.g., read) a guest virtual machine's (e.g., trust domain's) private data according to examples of the disclosure.

FIG. 5 illustrates a block diagram of a host including a trust domain manager that utilizes an encrypted shared memory of virtual machines (e.g., trust domains) to implement VDK provisioning (e.g., a provisioning application programming interface (API)) securely according to examples of the disclosure.

FIG. 6 is a flow diagram illustrating operations of a method for provisioning a VDK according to examples of the disclosure.

FIG. 7 is a flow diagram illustrating operations of a method for encrypting a virtual machine's (e.g., trust domain's) private data via a VDK according to examples of the disclosure.

FIG. 8 is a flow diagram illustrating operations of a method for removing a VDK according to examples of the disclosure.

FIG. 9 is a flow diagram illustrating operations of a method for encrypting and storing a virtual machine's (e.g., trust domain's) private data via a VDK according to examples of the disclosure.

FIG. 10 is a block diagram including a trust domain (e.g., confidential VM) that also functions as the debug agent for a tenant workload in the trust domain that is authorized to view a debug file and to debug the image encrypted by a VDK according to examples of the disclosure.

FIG. 11 is a block diagram of a remote debug client (RDC) that is authorized to view a debug file from a guest-host VM (e.g., TD) and to decrypt an encrypted debug image using the VDK for decryption by the RDC (e.g., on a system in debug mode) according to examples of the disclosure.

FIG. 12 is a flow diagram illustrating operations of a method for debugging a virtual machine's (e.g., trust domain's) private data according to examples of the disclosure.

FIG. 13 illustrates an example computing system.

FIG. 14 illustrates a block diagram of an example processor and/or System on a Chip (SoC) that may have one or more cores and an integrated memory controller.

FIG. 15A is a block diagram illustrating both an example in-order pipeline and an example register renaming, out-of-order issue/execution pipeline according to examples.

FIG. 15B is a block diagram illustrating both an example in-order architecture core and an example register renaming, out-of-order issue/execution architecture core to be included in a processor according to examples.

FIG. 16 illustrates examples of execution unit(s) circuitry.

FIG. 17 is a block diagram of a register architecture according to some examples.

FIG. 18 illustrates examples of an instruction format.

FIG. 19 illustrates examples of an addressing information field.

FIG. 20 illustrates examples of a first prefix.

FIGS. 21A-D illustrate examples of how the R, X, and B fields of the first prefix in FIG. 20 are used.

FIGS. 22A-B illustrate examples of a second prefix.

FIG. 23 illustrates examples of a third prefix.

FIG. 24 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for debugging a confidential virtual machine (e.g., a trust domain) for a processor in production mode.

In the following description, numerous specific details are set forth. However, it is understood that examples of the disclosure may be practiced without these specific details. In other instances, well-known circuits, structures, and techniques have not been shown in detail in order not to obscure the understanding of this description.

References in the specification to “one example,” “an example,” “examples,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Certain operations include accessing one or more memory locations, e.g., to store and/or read (e.g., load) data. A system may include a plurality of cores, e.g., with a proper subset of cores in each socket of a plurality of sockets, e.g., of a system-on-a-chip (SoC). Each core (e.g., each processor or each socket) may access data storage (e.g., a memory). Memory may include volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM) (e.g., an Intel® Optane™-memory), for example, accessible according to a Peripheral Component Interconnect Express (PCIe) standard.

In certain examples of computing, a virtual machine (VM) (e.g., guest) is an emulation of a computer system. In certain examples, VMs are based on a specific computer architecture and provide the functionality of an underlying physical computer system. Their implementations may involve specialized hardware, firmware, software, or a combination. In certain examples, a virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage, and other input/output (IO) resources, such as, but not limited to, an input/output memory management unit (IOMMU) (e.g., an IOMMU circuit). The VMM may provide a centralized interface for managing the entire operation, status, and availability of VMs that are installed over a single host machine or spread across different and interconnected hosts.

It may be desirable to maintain the security (e.g., confidentiality) of information for a virtual machine from the VMM and/or other virtual machine(s). Certain processors (e.g., a system-on-a-chip (SoC) including a processor) utilize their hardware to isolate virtual machines, for example, with each referred to as a “trust domain” (e.g., a “trusted area” or “secure area”). Certain processors support an instruction set architecture (ISA) (e.g., ISA extension) to implement trust domains. For example, Intel® trust domain extensions (Intel® TDX) that utilize architectural elements to deploy hardware-isolated virtual machines (VMs) referred to as trust domains (TDs).

In certain examples, a hardware processor (e.g., a trust domain manager thereof) and its ISA isolates TD VMs from the VMM (e.g., hypervisor) and/or other non-TD software (e.g., on the host platform). In certain examples, a hardware processor (e.g., a trust domain manager thereof) and its ISA implement trust domains to enhance confidential computing by helping protect the trust domains from a broad range of software attacks and reducing the trust domain's trusted computing base (TCB). In certain examples, a hardware processor (e.g., a trust domain manager thereof) and its ISA enhance a cloud tenant's control of data security and protection. In certain examples, a hardware processor (e.g., a trust domain manager thereof) and its ISA implement trust domains (e.g., trusted virtual machines) to enhance a cloud-service provider's (CSP) ability to provide managed cloud services without exposing tenant data to adversaries.

However, in certain examples, privileged system code (e.g., OS, VMM, and/or firmware) has access (e.g., to read and/or write) to memory that is storing data. This is a problem particularly where the data is to be kept private (e.g., the confidential information in memory for a trust domain) from the privileged (e.g., kernel/system level and/or not user level) system code. Certain examples herein (e.g., that implement trust domains) eliminate privileged software from the trusted compute base (TCB), e.g., the TCB of a TD.

Certain architectures support two modes of operation for enclaves (e.g., trust domains): (1) debug mode and (2) production (e.g., non-debug) mode. In certain examples, production mode enclaves (e.g., trust domains) have the full protection provided by the architecture. In certain examples, to support enclave debug mode enclaves differ from production mode enclaves in one or more of the followings ways.
(i) In certain examples, debug mode enclaves are created with an ATTRIBUTES.DEBUG bit set (e.g., where this field appears in the output (e.g., REPORT.ATTRIBUTES) of an enclave report (e.g., EREPORT) instruction). In certain examples, the debug bit is not measured as part of the build process, so debug and production enclaves can have the same measurement, e.g., where this ensures that reports generated by activities (e.g., attestation) will look the same, which helps simplify the debugging process.
(ii) In certain examples, keys returned by an enclave get key (e.g., EGETKEY) instruction leaf in debug enclaves are different for the same enclave in debug vs. production modes, e.g., where data sealed by a production enclave cannot be inspected by a debug enclave (and vice versa), which helps ensure protection of secrets.
(iii) In certain examples, debug mode enclaves can be debugged using a debugger (for example, Intel® software guard extensions (SGX) debugger, e.g., and debuggers that do not support SGX cannot debug enclaves under any circumstances).
(iv) In certain examples, performance counters are enabled inside debug mode enclaves, e.g., where these counters can be used for performance tuning enclaves.

In certain examples, a processor (e.g., core) is to implement a host virtual machine monitor (host VMM) that serves as a host to guest TDs, e.g., where the term “host” is used to differentiate between the “host VMM” and future VMMs that may be nested within trust domains.

In certain examples, a processor (e.g., core) is to implement a trust domain manager, e.g., where the trust domain manager is to manage one or more trust domains (TDs) that are designed to be hardware isolated virtual machines (VMs), e.g., utilizing a set of ISA extensions (e.g., Intel® Trust Domain Extensions (Intel® TDX)).

In certain examples, a processor (e.g., core) is to implement a debug architecture for a trust domain manager that includes the following debug functionality: (i) On-TD Debug: functionality for debugging a guest TD using software that runs inside the TD (e.g., from within the “guest” side), and/or (ii) Off-TD Debug: functionality for debugging a guest TD, configured in debug mode, using software that runs outside the TD (e.g., from within the “host” side) (e.g., via a host side Off-TD Debug interface in a development environment).

However, option (2) implies the VMM is trusted with TD contents. In certain examples, debug code (e.g., a debug agent) resides inside the guest TD, and it can interact with external entities (e.g., a debugger) via standard input/output (I/O) interfaces. In certain examples, a trust domain manager is designed to virtualize and isolate TD debug capabilities from the host VMM and other guest TDs or legacy VMs. In certain examples, On-TD debug can be used for production or debug TDs, e.g., regardless of the guest TD's debug attribute (e.g., ATTRIBUTES.DEBUG) state. In certain examples, a host VMM controls whether a guest TD can use performance monitoring functionality of a processor (e.g., use a performance monitoring ISA), for example, controlled using the TD's performance monitoring attribute (e.g., ATTRIBUTES.PERFMON) bit, e.g., as part of a trust domain's parameters (e.g., TD_PARAMS input to TDH.MNG.INIT 5).

In certain examples, a processor is to generate a memory dump file (e.g., with the data therein referred to as a memory dump, core dump, storage dump, crash dump, and/or system dump). In certain examples, the memory dump file includes the recorded state of the working memory of a computer program (e.g., application and/or OS) at a specific time, e.g., generated in response to the program crashing or otherwise terminated abnormally. In certain examples, the memory dump file includes processor state, e.g., including the processor registers (e.g., which may include the program counter and stack pointer), memory management information, and/or other processor and operating system information (e.g., flags).

In certain examples, a host operating system is allowed access to a memory dump file, but a guest program (e.g., guest application and/or guest OS) is not allowed access to the memory dump file. In certain examples, the guest program (for example, running on a virtual machine, e.g., trust domain) sends its requests to the VMM, but as noted above, in certain examples, the VMM is not trusted by the trust domain manager, and is thus not allowed access to a dump file, e.g., as that dump file is encrypted by a private virtual machine encryption key (e.g., VEK) that the VMM is not allowed access to.

In certain examples, it may be desirable to have off-TD debug of a guest program (e.g., a guest application and/or guest operating system (OS)) where that memory dump is confidential data of that guest program, e.g., and thus protected by a corresponding VEK that is not to be shared with the untrusted VMM. Examples herein are directed to methods and circuitry that overcomes these issues by generating and/or using a debug key (e.g., virtual machine debug key (VDK)). Examples herein are directed to new capabilities that allow a VMM to dump and/or access confidential VM's private data and/or memory (e.g., via a host to host interface in production mode) while protecting the confidentiality and integrity of the VM's private data and/or memory. Examples herein thus prevent data leakage, e.g., of confidential data. Examples herein allow a host VMM to dump guest VM private memory space in a production environment without security compromise, e.g., to facilitate guest VM's development, debug, and/or management in confidential computing (CC).

In certain examples, the use of a virtual machine (e.g., trust domain) debug key disclosed herein is an improvement to the functioning of a SoC (e.g., processor) (e.g., of a computer) itself as it allows for the SoC (e.g., processor) to prevent data in the virtual machine's (e.g., trust domain's) protected memory from being accessed by a non-desired entity, e.g., but still allowing a VMM to access the protected data to perform a debug. As one example, a guest OS operating in a trust domain is not allowed access to a dump file generated in that trust domain (e.g., generated when a guest application running in that trust domain crashes) because when the guest OS requests the VMM to perform that access, it is denied as a non-trusted entity. Examples herein allow for the private data to be encrypted by a dump key (e.g., that is separate/unique from an encryption key of the code and/or other data in the trust domain) and thus the VMM (or another entity) to perform debug operations on that private data when the VMM (or another entity) is provided the dump key. Examples herein are directed to methods and apparatuses to debug confidential virtual machines (e.g., while in production mode).

In certain examples, confidential computing (CC) uses memory encryption to protect a guest VM's confidentiality and integrity, e.g., where a target VM's private memory is encrypted with a private VM Encryption Key (VEK) and the VEK is managed by a privileged trust domain managers (e.g., Trust Module). For example, certain Intel® Trust Domain Extensions (Intel® TDX) work with an Intel® Multi-Key Total Memory Encryption (MKTME) circuitry (e.g., engine) to apply VM memory encryption and introduce a trust module (e.g., Intel® TDX Module) to manage guest Trust Domain's (TD's) VEK and other secrets. For example, certain AMD® processors include a Secure Encrypted Virtualization-Encrypted State (SEV-ES) and/or SEV-Secure Nested Paging (SEV-SNP) hardware memory encryption engine (e.g., embedded in a memory controller) to encrypt VM's memory and use processor hardware as the trust module to manage a guest SEV's VEK.

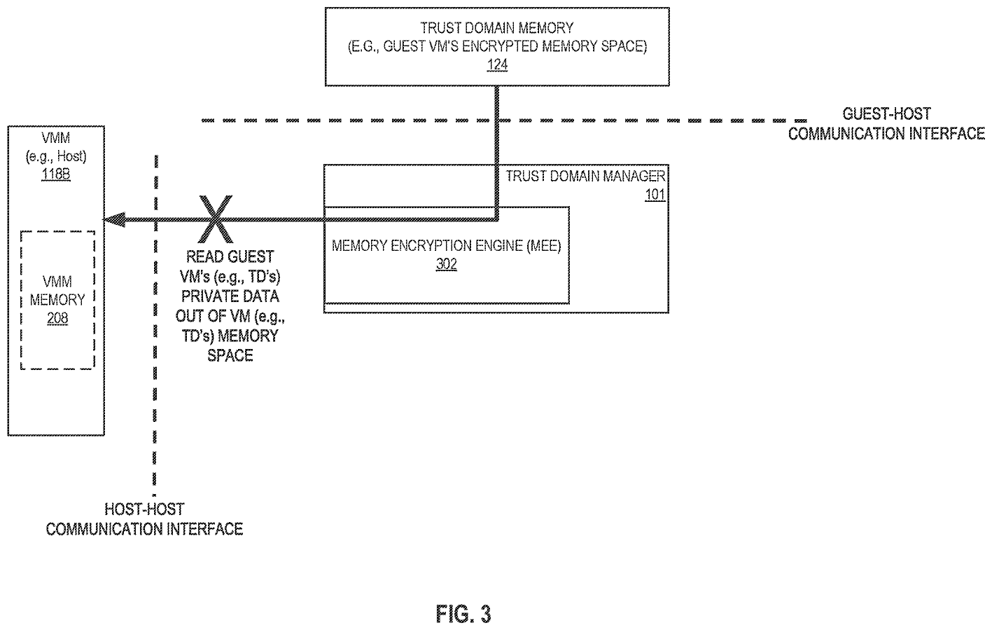

In certain CC solutions, the VMM is untrusted, and thus a trust domain manager disallows the VMM from accessing the VM's private memory space (e.g., in production mode) (see, e.g., FIG. 3) and thus prevents the debug of a guest VM (e.g., in a production and/or deployed environment in contrast to a development and/or manufacturing environment). While this constraint may be appropriate for production deployments, is overly restrictive for tenant-driven VM debugging. In certain examples, guest VM private memory encryption introduces a significant functional regression, where dumping/accessing guest VMs' memory space from VMM is an important function for tenants and/or cloud service providers (CSPs) for debugging (e.g., dumping a misbehaving VM core file to debug issues offline).

Without the ability to dump (or view the plaintext of an encrypted dump) a guest VM, debugging of guest programs (e.g., guest OS/applications) is extremely difficult post-production. Lack of a post-production debugging capability breaks conventional VM management methods. Examples herein enable confidential guest VM memory space and/or data access (e.g., in production mode) while retaining the security thereof, e.g., where such functionality is included for AMD® Secure Encrypted Virtualization (e.g., SEV/SEV-ES/SEV-SNP), Intel® Trusted Execution Technology, ARM® Realm Management Extension (RME), or other confidential computing technology.

Examples herein do not rely on a stable guest TD OS and/or require that Off-TD Debug only applies to a development environment where a host VMM is trusted implicitly, for example, the examples herein are usable n a cloud environment, e.g., where tenants are working in a production environment where the VMM is untrusted. Examples herein are defense against a malicious VMM's attack, e.g., to prevent the VMM from observing the memory dump file's content (e.g., unless allowed by the trust domain manager via the VDK).

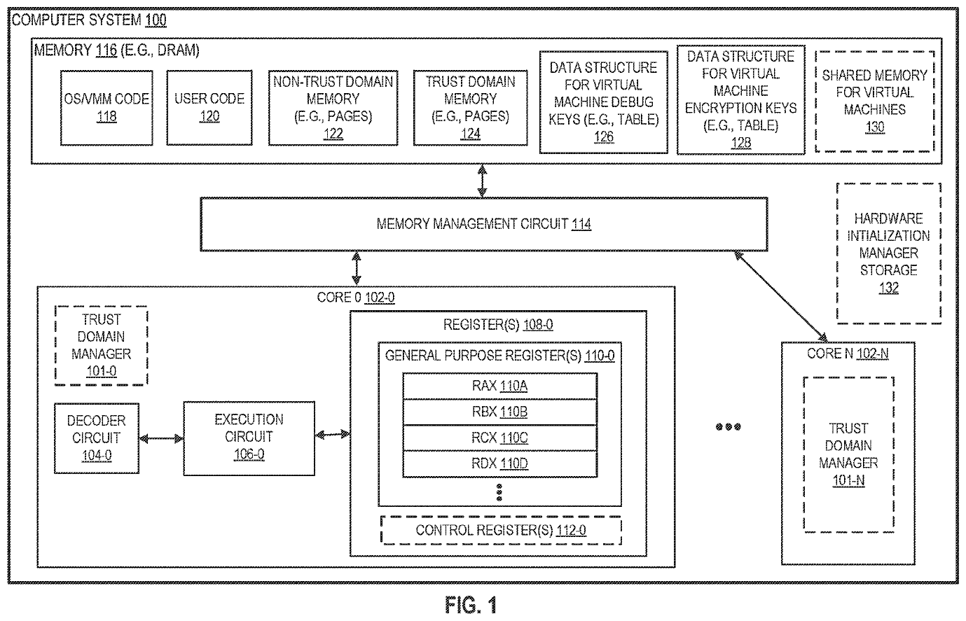

Turning now to FIG. 1, an example system architecture is depicted. FIG. 1 illustrates a block diagram of a computer system including a plurality of cores 102-0 to 102-N (e.g., where N is any positive integer greater than one, although single core examples may also be utilized) having a trust domain manager (e.g., a single trust domain manager or distributed trust domain managers 101-0 to 101-N in each core, respectively), a memory management circuit 114, and a memory 116 including (e.g., only accessible by a trust domain manager) storage for a data structure for virtual machine debug keys (VDKs) 126 according to examples of the disclosure. In certain examples,

In certain examples, each core includes (e.g., or logically includes) a set of registers, e.g., registers 108-0 for core 102-0, registers for core 102-N, etc. Registers 108 may be data registers and/or control registers, e.g., for each core (e.g., or each logical core of a plurality of logical cores of a physical core).

In certain examples, a (e.g., each) hardware processor core (e.g., core 102-0) includes a (i) hardware decoder circuit 104-0 to decode an instruction, e.g., an instruction that is to request access to a block (or blocks) of memory (e.g., trust domain memory 124) and/or (ii) a hardware execution circuit 106-0 to execute the decoded instruction, e.g., an instruction that is to request access to a block (or blocks) of memory.

Depicted hardware processor core 102-0 includes one or more registers 108-0, for example, general purpose (e.g., data) register(s) 110-0 (e.g., registers RAX 110A, RBX 110B, RCX 110C, RDX 110D, etc.) and/or (optional) (e.g., dedicated only for capabilities) control register(s) 112-0 (e.g., registers to control the use of a VEK and/or VDK).

In certain examples, one or more of the cores 102 are coupled to memory 116 via a memory management circuit 118. In certain examples, memory management circuit 118 is to control access (e.g., by the execution circuit 106-0) to the (e.g., addressable memory of) memory 116.

In certain examples, memory 116 is a memory local to the hardware processor (e.g., system memory). Memory 116 may be DRAM. In certain examples, memory 116 is a memory separate from the hardware processor, for example, memory of a server. Note that the figures herein may not depict all data communication connections. One of ordinary skill in the art will appreciate that this is to not obscure certain details in the figures. Note that a double headed arrow in the figures may not require two-way communication, for example, it may indicate one-way communication (e.g., to or from that component or device). Any or all combinations of communications paths may be utilized in certain examples herein.

Memory 116 contents may include operating system (OS) and/or virtual machine monitor code 118, user (e.g., program) code 120, non-trust domain memory 122 (e.g., pages), trust domain memory 124 (e.g., pages), (e.g., only accessible by a trust domain manager) storage for a data structure for virtual machine (e.g., trust domain) debug keys (VDKs) 126, (e.g., only accessible by a trust domain manager) storage for a data structure for virtual machine (e.g., trust domain) encryption keys (VEKs) 128, a shared memory for virtual machines 130 (e.g., shared memory for trust domains), or any combination thereof. In certain examples of computing, a virtual machine (VM) is an emulation of a computer system. In certain examples, VMs are based on a specific computer architecture and provide the functionality of an underlying physical computer system. Their implementations may involve specialized hardware, firmware, software, or a combination. In certain examples, the virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage, and other input/output (IO) resources, such as, but not limited to, an input/output memory management unit (IOMMU). The VMM may provide a centralized interface for managing the entire operation, status, and availability of VMs that are installed over a single host machine or spread across different and interconnected hosts. Similarly, an operating system may support multiple processes in separate address spaces defined by their respective paging structures to separate one process's memory pages from another process's memory pages.

In certain examples, the hardware initialization manager (non-transitory) storage 132 stores hardware initialization manager firmware (e.g., or software). In one example, the hardware initialization manager (non-transitory) storage 132 stores Basic Input/Output System (BIOS) firmware. In another example, the hardware initialization manager (non-transitory) storage 136 stores Unified Extensible Firmware Interface (UEFI) firmware. In certain examples (e.g., triggered by the power-on or reboot of a processor), computer system 100 (e.g., core 102-0) executes the hardware initialization manager firmware (e.g., or software) stored in hardware initialization manager (non-transitory) storage 132 to initialize the system 100 for operation, for example, to begin executing an operating system (OS) and/or initialize and test the (e.g., hardware) components of system 100.

In certain examples, a trusted execution environment (TEE) security manager (e.g., implemented by a trust domain manager 101) is to: provide interfaces to the VMM to assign memory, processor, and other resources to trust domains (e.g., trusted virtual machines), (ii) implements the security mechanisms and access controls (e.g., translation tables, etc.) to protect confidentiality and integrity of the trust domains (e.g., trusted virtual machines) data and execution state in the host from entities not in the trusted computing base of the trust domains (e.g., trusted virtual machines), (iii) uses a protocol to manage the security state of the trusted device interface (TDI) to be used by the trust domains (e.g., trusted virtual machines), (iv) establishing/managing IDE encryption keys for the host, and, if needed, scheduling key refreshes. TSM programs the IDE encryption keys into the host root ports and communicates with the DSM to configure integrity and data encryption (IDE) encryption keys in the device, (v) or any single or combination thereof. In certain examples, a TEE security manager (e.g., also) provides authentication and attestation services where code and data are measured, and the measurement is sent to a remote entity to prove the code and data is loaded and running in the TEE on an authenticated machine.

In certain examples, an endpoint's (e.g., code's) “measurement” describes the process of calculating the cryptographic hash value of a piece of firmware/software or configuration data and linking the cryptographic hash value with the trusted execution environment endpoint identity through the use of digital signatures. This allows an authentication initiator to establish that the identity and measurement of the firmware/software or configuration running on the authenticated trusted execution environment endpoint.

In certain examples, to help enforce the security policies for the TDs, a new mode of a processor called Secure-Arbitration Mode (SEAM) is introduced to host a (e.g., manufacturer provided) digitally signed, but not necessarily encrypted, security-services module. In certain examples, a trust domain manager (TDM) 101 is hosted in a reserved, memory space identified by a SEAM-range register (SEAMRR). In certain examples, the processor only allows access to SEAM-memory range to software executing inside the SEAM-memory range, and all other software accesses and direct-memory access (DMA) from devices to this memory range are aborted. In certain examples, a SEAM module does not have any memory-access privileges to other protected, memory regions in the platform, including the System-Management Mode (SMM) memory or (e.g., Intel® Software Guard Extensions (SGX)) protected memory.

In certain examples, trust domain manager (e.g., trust domain manager 101-0 to 101-N) assigns a VEK to each virtual machine (e.g., trust domain) to maintain the confidentiality of each virtual machine. As discussed further herein, in certain examples, trust domain manager (e.g., trust domain manager 101-0 to 101-N) assigns a dump key (e.g., VDK) to a virtual machine (e.g., trust domain) to allow an entity separate from the trust domain and trust domain manager (e.g., to allow the VMM) to access a dump file encrypted with that dump key (e.g., VDK), e.g., where the VDK is different than the VEK for that trust domain that generated the dump file.

In certain examples, privileged system code (e.g., OS and/or VMM code 124) is to provide (e.g., allocate) memory to the trust domain manager 101 for use by a trust domain to insert code and/or data.

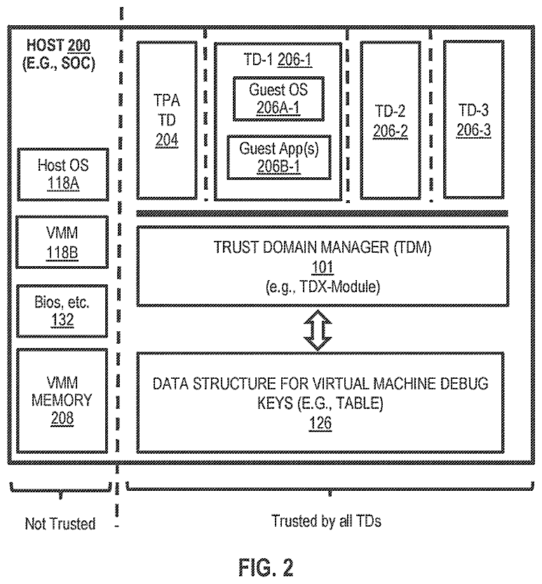

FIG. 2 illustrates a block diagram of a host (e.g., an instance of computer system 100 in FIG. 1) including a trust domain manager and storage for a data structure 126 for VDKs according to examples of the disclosure.

In certain examples, host 200 implements a trusted provisioning agent (TPA) 204 of trust domains, and a plurality of trust domains, shown as trust domain “1” 206-1, trust domain “2” 206-2, and trust domain “3” 206-3, although any single or plurality of trust domains may be implemented. In certain examples, host 200 includes a trust domain manager 101 to manage the trust domains (for example, with the vertical dashed lines indicating isolation therebetween the trust domains, e.g., and host OS 118A, VMM 118B, BIOS 136, VMM memory 208 (e.g., non-secure TDM memory), etc.). In certain examples, the virtual machine monitor 118B manages (e.g., generates) one or more virtual machines, e.g., with the trust domain manager 101 isolating a first virtual machine as a first trust domain from a second (or more) virtual machine as a second (or more) trust domain(s).

In certain examples, a trust domain has both a private memory (e.g., in trust domain memory 124 in FIG. 1) and a shared memory 130 (e.g., in trust domain memory 124 in FIG. 1). In certain examples, trust domain manager 101 accesses data structure 126 for VDKs to manage encryption (and/or decryption) of a dump file via a corresponding VDK.

As one example, guest OS 206A-1 operating in a trust domain 206-1 is not allowed access to a dump file generated in (e.g., and stored in) that trust domain 206-1 (e.g., generated when a guest application 206B-1 running in that trust domain 206-1 crashes) because when the guest OS 206A-1 requests the VMM 118B to perform that access within trust domain 206-1, it is denied because the VMM 118B is a non-trusted entity. Instead of adding the VMM 118B as a trusted entity, examples herein allow for the private data to be encrypted by a dump key from the data structure of VDKs 126 (e.g., where that dump key is separate/unique from an encryption key of the code and/or other data in the trust domain) and thus the VMM 118B (or another entity, e.g., a trusted entity) to perform debug operations on that private data when the VMM (or another entity, e.g., a trusted entity) is provided the dump key, for example, via the VDK-encrypted memory dump being stored in the VMM memory 208 (e.g., and the VMM provided the VDK to allow debugging via the VDK-decrypted memory dump). In certain examples, an environment (e.g., environment X) is authorized to debug, for example, and is thus provided the corresponding VDK of a VDK-encrypted memory dump. That authorization may include the environment (for example, trusted entity, e.g., not the untrusted VMM) having access to a decryption key (e.g., VDK) that is used to decrypt a debug image. Authorization may also include access to hardware, VMM, and/or OS debug modes, e.g., including access to physical ports for debugging such as, but not limited to, a Joint Test Action Group (JTAG) port, e.g., where JTAG is the common name for what is standardized as the IEEE 1149.1 Standard Test Access Port and Boundary-Scan Architecture (2013). Debugging and testing according to the IEEE 1149.1-2013 (JTAG) standard may include testing printed circuit boards (e.g., using boundary scan), integrated circuits (e.g., processors, controllers, etc.), embedded systems, and other components.

In certain examples, the trust domain manager 101 has write access to the untrusted memory (e.g., VMM memory 208), but such access does not make the trust domain manager 101 untrusted, e.g., it is only writing a VDK-encrypted dump file to that memory (e.g., VMM memory 208).

Turning now to FIG. 3, allowing the VMM access (e.g., via the trust domain manager 101) may be undesirable, e.g., where the VMM is not trusted. FIG. 3 illustrates a block diagram of a host, in production mode, including a trust domain manager 101 (e.g., having a memory encryption engine 302) that disallows a host virtual machine monitor (VMM) 118B (e.g., including memory 208 outside of the trust domain(s)) from accessing (e.g., reading) a guest virtual machine's (e.g., trust domain's) private data out of the guest virtual machine's (e.g., trust domain's) memory space 124 according to examples of the disclosure. In certain examples, the VDK logically changes the behavior of the host-host interface. For example, where (e.g., in production mode), if a VDK does not exist, the host-host interface is not allowed to access trust domain memory 124 (e.g., guest VM memory). In certain examples (e.g., in a debug mode that is not the production mode) the host-host interface is allowed to access trust domain memory 124 (e.g., guest VM memory), e.g., whether the VDK exists or not.

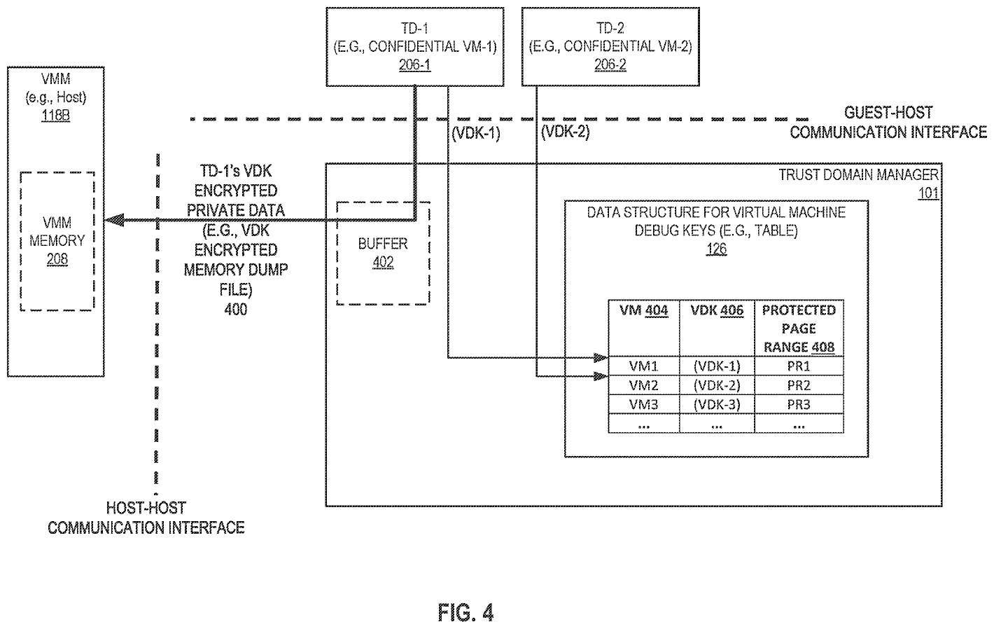

FIG. 4 illustrates a block diagram of a host including a trust domain manager 101 that utilizes one or more VDKs to allow a host virtual machine monitor (VMM) 118B to access (e.g., read) a guest virtual machine's (e.g., trust domain's) private data (e.g., within trust domain(s) 206) according to examples of the disclosure. In certain examples, the VMM 118B is considered a host (e.g., in contrast to a guest which has less privileged/access on a processor), the trust domain manager 101 is also considered a host, while the trust domains (e.g., confidential VMs protected by a corresponding VEK, see, e.g., FIG. 4) are guests (e.g., guests that are managed by the trust domain manager 101). In certain examples, e.g., in contrast to FIG. 3, FIG. 4 illustrates a trust domain manager causing a trust domain's private dump file (e.g., memory dump file) to be encrypted via a corresponding dump key (e.g., VDK from data structure 126), e.g., and that encrypted version (e.g., ciphertext) stored into memory (e.g., memory outside of the trust domain that generated the dump file) (e.g., VMM memory 208). FIG. 4 illustrates that, in response to generation of a dump file by code (e.g., the crashing of that code) from the first trust domain (TD-1) 206-A, trust domain manager 101 is to encrypt that dump file via a VDK (e.g., VDK-1 in FIG. 4) (e.g., although the dump file may need to be decrypted by the system key and that plaintext then encrypted by the VDK), e.g., and cause that VDK-encrypted dump file to be stored into memory (e.g., VMM memory 208). In certain examples, the trust domain manager 101 includes a buffer 402 for storing the dump file for encryption (or decryption).

In certain examples, the trust domain manager 101 (e.g., MEE 302 thereof) performs (i) encryption by taking data (e.g., plaintext), and performing an encryption based on that key to generate encrypted data (e.g., ciphertext) and/or (ii) decryption by taking encrypted data (e.g., ciphertext), and performing a decryption based on that key to generate that data (e.g., plaintext).

In certain examples, each entry of the data structure (e.g., table) of VDKs 126 includes one or more of an indication 404 of a particular VM (e.g., trust domain), an indication 406 of its corresponding dump key, and/or (optionally) an indication 408 of a protected page range. In certain examples, the trust domain manager is to populate the VDK field 406 (e.g., and/or protected page range 408) for a VM (e.g., TD) on creation of the VM (e.g., TD), for example, assuming the TD is opting in (and not opting out) of having a VDK. In certain examples, data structure 126 and/or data structure 128 of VEKs are only accessible (e.g., readable and/or writable) by trust domain manager 101).

In certain examples, a VDK is used for guest to trust domain manager (TDM) communications, e.g., in contrast to a remote debug client (RDC) key which is used for RDC to guest/TDM communication.

In certain examples, the VDK logically changes the behavior of the host-host interface. For example, where (e.g., in production mode), if a VDK does not exist, the host-host interface is not allowed to access trust domain memory 124 (e.g., guest VM memory). In certain examples (e.g., in a debug mode that is not the production mode) the host-host interface is allowed to access trust domain memory 124 (e.g., guest VM memory), e.g., whether the VDK exists or not.

Examples herein defend against confidential VM (e.g., TD) data leakage, by the trust domain manager encrypting the target VM's private (e.g., confidential) data (e.g., for the target VM's private memory) according to a VM debug key (VDK) during debug memory dump/access. In certain examples, this includes one or more of:
(i) VDK provisioning: where the target VM's VDK is provisioned by a guest VM itself to ensure only the VM owner (e.g., “tenant”) can decrypt the encrypted (e.g., memory dump) file in certain examples. In certain examples, a key provision application programming interface (API) is introduced in a VM Guest-Host interface to achieve a VDK provision, deletion, and/or update.
(ii) VDK data structure 126 (e.g., table): the trust domain manager (e.g., trust module) maintain the VDK within an internal key data structure, e.g., such that only the trust domain manager and target VM have key access privileges (e.g., and the target VM can only access its VDK and none of the other VDKs).
(iii) Debug APIs Extension: extend Host-Host Debug APIs (e.g., a read command (e.g., TDH.MEM.RD of Intel® TDX) to access a non-debuggable guest VM's private data, e.g., as the data (e.g., cipher) will be encrypted by VDK, no security compromises are introduced.
(iv) Intermedia buffer; in certain examples, the VM dump file (e.g., core file) is relatively large, so a bounce memory space (e.g., buffer 402) is included, e.g., as an intermedia buffer for guest private data encryption via the VDK during dumping.

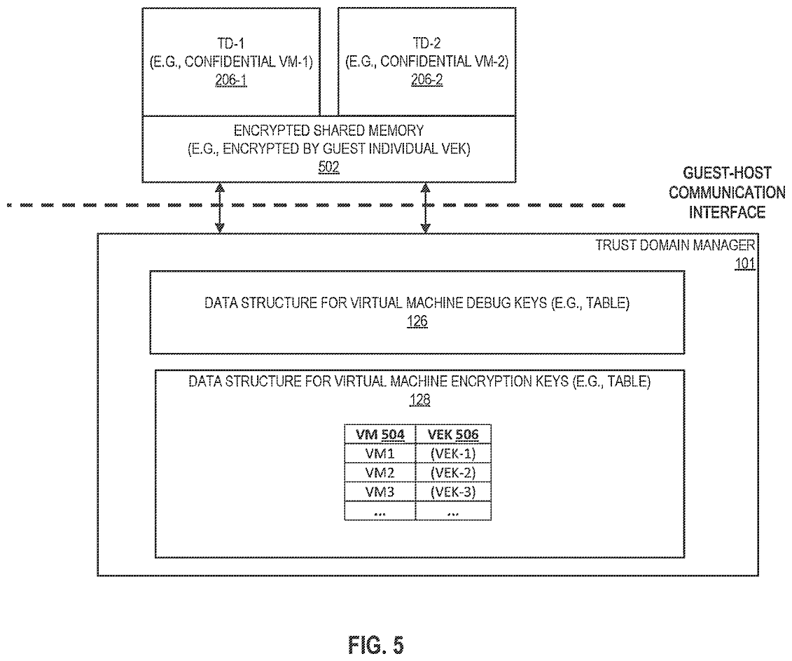

FIG. 5 illustrates a block diagram of a host including a trust domain manager 101 that utilizes an encrypted shared memory 502 of virtual machines (e.g., trust domains 206-1 and 206-2) to implement VDK provisioning (e.g., a provisioning application programming interface (API)) securely according to examples of the disclosure. In certain examples, when a guest VM (e.g., TD) is created (e.g., boots), the tenant (e.g., guest OS and/or guest application) invoke the VDK provision API to provision a VDK to the trust domain manager 101, e.g., where this process happens in guest VM private environment to ensure the VDK's confidentiality and integrity.

In certain examples, the VDK provision API is implemented via guest-host communication interface based on the shared memory 502, e.g., because the shared memory is encrypted by the VEK and the VEK is managed by the trust domain manager 101, the trust domain manager 101 can get the authentic API invoker (e.g., key owner) via VEK. In certain examples, each entry of the data structure (e.g., table) of VEKs 128 includes one or more of an indication 504 of a particular VM (e.g., trust domain), an indication 506 of its corresponding (e.g., non VDK) encryption key, and/or (optionally) an indication of a protected page range.

In certain examples, the trust domain manager is to store the provisioned (e.g., generated) VDK into the VDK data structure 126 (e.g., table) with an indication of the key owner (e.g., TD). In certain examples, the tenant (e.g., guest OS/applications) of a VM (e.g., TD) is to update and/or delete a VDK, e.g., via a VDK provision API.

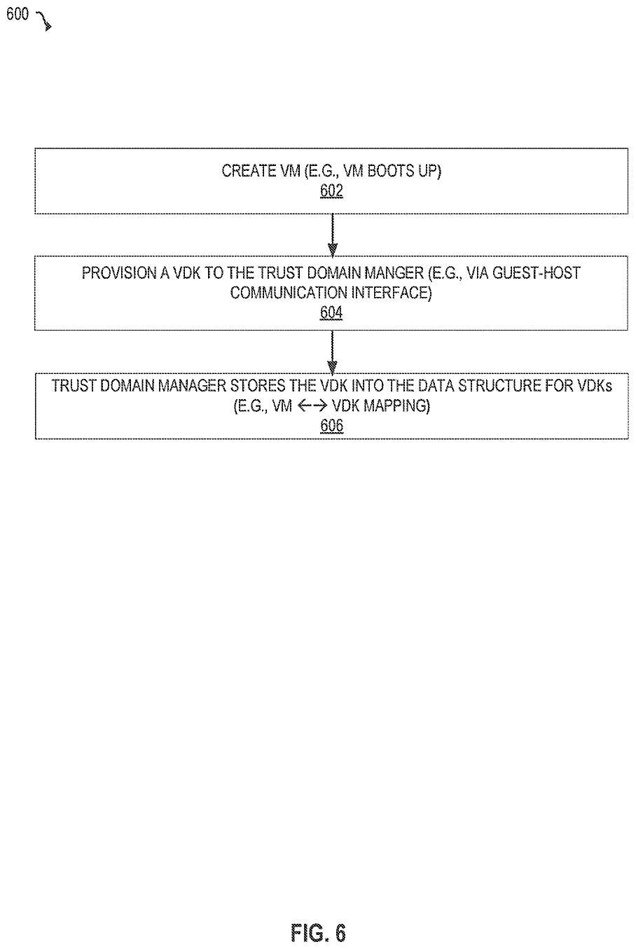

FIG. 6 is a flow diagram illustrating operations 600 of a method for provisioning a VDK according to examples of the disclosure. Some or all of the operations 600 (or other processes described herein, or variations, and/or combinations thereof) are configured under the control of a trust domain manager (or other components discussed herein) as implemented herein and/or one or more computer systems (e.g., processors) configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 600 are performed by trust domain manager 101 of the other figures.

The operations 600 include, at block 602, creating a VM (e.g., TD) (e.g., VM boot up). The operations 600 further include, at block 604, provision a VDK to the trust domain manager, e.g., via guest-host communication interface. The operations 600 further include, at block 606, trust domain manager stores the VDK into the data structure for VDKs (e.g., showing the VM (e.g., TD) to VDK (e.g., TD-debug key (TDDK) mapping). In certain examples, there is a VDK used for secure communications, e.g., in contrast to a VDK that is exclusively used for encrypting a dump image. This can be indicated in data structure 126. For example, there can be a VDK (e.g., symmetric or asymmetric), VDK-debug (e.g., symmetric or asymmetric), and a key encryption key (KEK) (e.g., asymmetric cryptosystem, such as, but not limited to, RSA). In certain examples, if a VDK-debug is omitted (e.g., for resource constrained environments), then VDK can be a multi-purpose key.

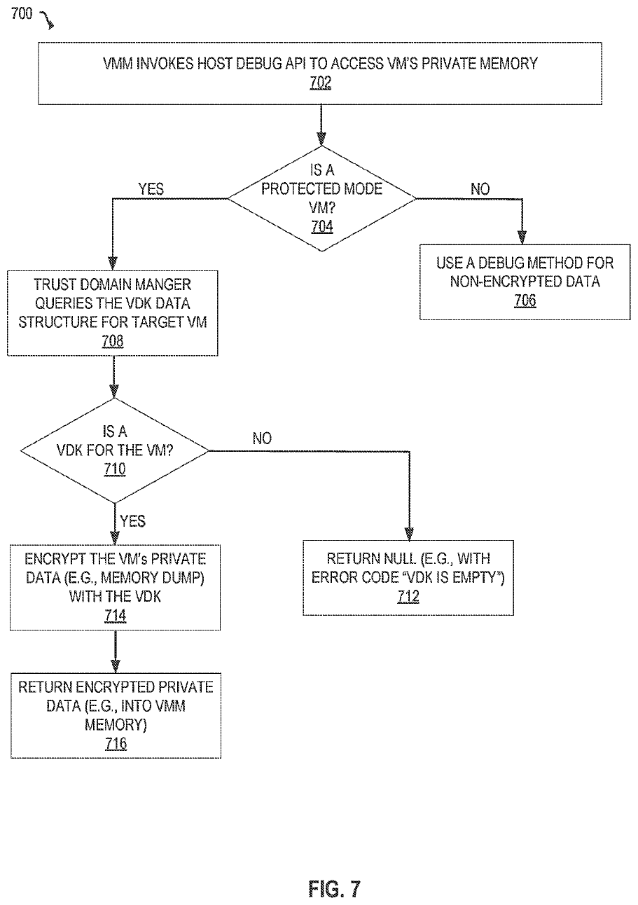

In certain examples, a trust domain manager is to encrypt VM's private memory when VMM access VM private memory via debug API, see, e.g., FIG. 7.

FIG. 7 is a flow diagram illustrating operations 700 of a method for encrypting a virtual machine's (e.g., trust domain's) private data (e.g., for a guest VM of a processor in production mode) via a VDK according to examples of the disclosure. Some or all of the operations 700 (or other processes described herein, or variations, and/or combinations thereof) are configured under the control of a trust domain manager (or other components discussed herein) as implemented herein and/or one or more computer systems (e.g., processors) configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 700 are performed by trust domain manager 101 of the other figures.

The operations 700 include, at block 702, a VMM requests the trust domain manager (e.g., via the VMM invoking a host debug API) to access VM's (e.g., TD's) private memory (e.g., private data therefrom). In certain examples, the request by the VMM at block 702 is generated in response to a guest program (e.g., guest OS/application) of the VM (e.g., TD) requesting the memory dump (e.g., requesting access to the memory dump file). The operations 700 further include, at block 704, checking if the VM (e.g., TD) is in a protected mode, for example, where the data of the VM is encrypted in protected mode and not-encrypted in unprotected mode. If “no” at block 704, the operations 700 proceed, at block 706, to using a debug method for non-encrypted data, and if “yes” at block 704, the operations 700 proceed, at block 708, to the trust domain manager querying the VDK data structure for that target VM (e.g., TD). The operations 700 further include, at block 710, checking if there is a corresponding VDK for the VM, and if “no”, proceeding, at block 712, to return a null (or other error indication), e.g., an error code that indicates “VDK is empty” for that VM, and if “yes”, proceeding, at block 714, to encrypting the VM's private data (e.g., memory dump) with the VDK, and then proceeding, at block 716, to return the encrypted private data (e.g., by storing the encrypted private data into VMM memory).

In certain examples, the use of a VDK (e.g., TDDK) allow for offline or remote debug in a secure environment, e.g., tenants can decrypt the encrypted memory (e.g., data therefrom) with the owned target VM's VDK and use a debug tool on the decrypted data (e.g., to check the memory space).

In certain examples, the trust domain manager is to manage the un-provisioning (e.g., cleanup) of a provisioned (e.g., generated) VDK, e.g., from the VDK data structure 126 (e.g., table). In certain examples, the trust domain manager defends against attacks (e.g., replay attack and/or denial-of-service (DOS)) attack by cleaning up (e.g., deactivating) a corresponding VDK (e.g., along with other VM resources) when its VM is destroyed (e.g., deactivated).

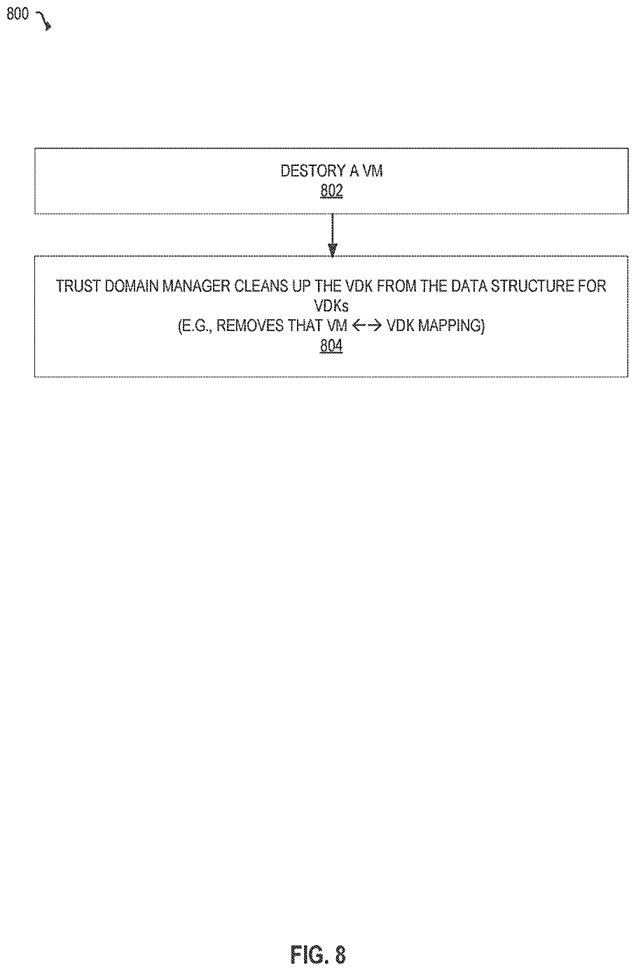

FIG. 8 is a flow diagram illustrating operations 800 of a method for removing a VDK according to examples of the disclosure. Some or all of the operations 800 (or other processes described herein, or variations, and/or combinations thereof) are configured under the control of a trust domain manager (or other components discussed herein) as implemented herein and/or one or more computer systems (e.g., processors) configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 800 are performed by trust domain manager 101 of the other figures.

The operations 800 include, at block 802, destroying a VM (e.g., TD) (e.g., in response to a corresponding request from its tenant). The operations 800 further include, at block 804, trust domain manager cleans up (e.g., deletes) the VDK for that VM from the data structure for VDKs (e.g., removes that VM to VDK mapping).

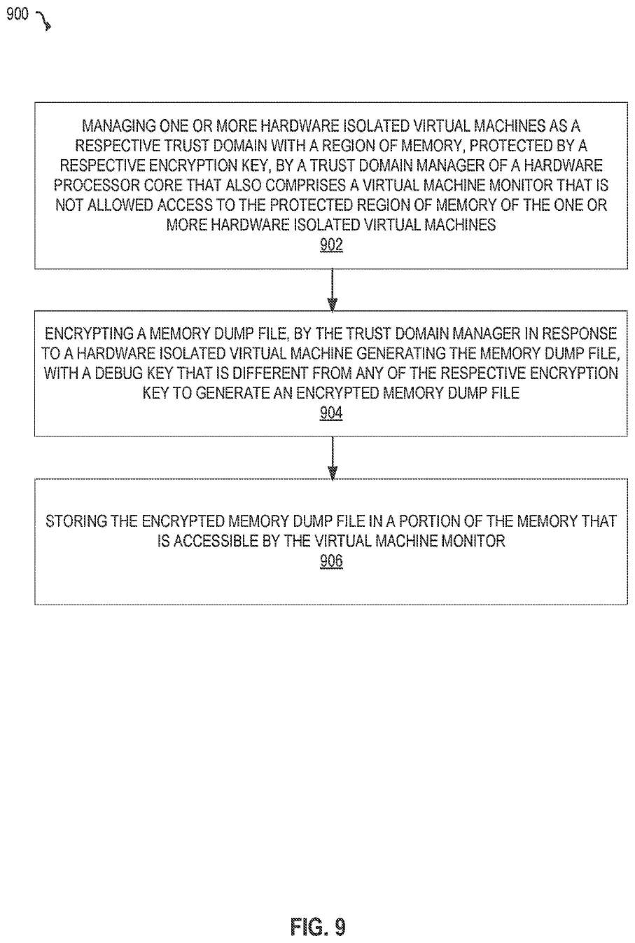

FIG. 9 is a flow diagram illustrating operations 900 of a method for encrypting and storing a virtual machine's (e.g., trust domain's) private data via a VDK according to examples of the disclosure. Some or all of the operations 900 (or other processes described herein, or variations, and/or combinations thereof) are configured under the control of a trust domain manager (or other components discussed herein) as implemented herein and/or one or more computer systems (e.g., processors) configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 900 are performed by a processor core, e.g., trust domain manager 101 thereof, of the other figures.

The operations 900 include, at block 902, managing one or more hardware isolated virtual machines as a respective trust domain with a region of memory, protected by a respective encryption key, by a trust domain manager of a hardware processor core that also comprises a virtual machine monitor that is not allowed access to the protected region of memory of the one or more hardware isolated virtual machines. The operations 900 further include, at block 904, encrypting a memory dump file, by the trust domain manager in response to a hardware isolated virtual machine generating the memory dump file, with a debug key that is different from any of the respective encryption key to generate an encrypted memory dump file. The operations 900 include, at block 906, storing the encrypted memory dump file in a portion of the memory that is accessible by the virtual machine monitor.

In certain examples, the memory dump (e.g., crash dump) is encrypted to the entity that has been set up for receiving encrypted crash dumps. In one example, the recipient of the memory dump could be anyone (e.g., any key), but the entity that is authorized to run the workload is also authorized to debug it. In another example, example, a workload might use a trained machine learning (ML) model that contains secrets (e.g., trade secrets), for example, there the ML model is being loaned to the VM to process the user's data set, but not authorized to steal the ML model. In this situation, a trusted third party may inspect the dump, but is bound to fiduciary protection of the user's data as well as the service providers AI model.

In certain examples, the routing of messages through the VMM is in the path that VM (e.g., TD) messages go through to get to its destination, but the trust model excludes the VMM from tampering with the memory dump, so examples herein allow the VM who is authorized to debug the image gets (e.g., exclusive) access to the image by virtue of encrypting the dump image to that VM, e.g., the VM-specific KEK wraps the dump image key (e.g., VDK-debug) such that only the VM is able to decrypt it.

In certain examples, a VM (e.g., TD) has pages mapped into its memory range such that it can access the memory as soon as the dump is stored therein. Prior to that the pages could be marked non-accessible or zero-filled. In certain examples, the VMM prevents access, e.g., by marking pages not readable or by putting a mutual exclusion object (e.g., mutex) guard on them. In certain examples, the trust domain manager writes the VDK-encrypted ciphertext into the memory pages in response to the dump (e.g., crash interrupt). In certain examples, on completion of the write, the trust domain manager signals the VMM telling it to remove the guard on the pages and to signal the TD that a crash dump is waiting. In certain examples, the TD has the VDK (e.g., decryption VDK) already since it needed to present the VDK (e.g., encryption VDK) to the trust domain manager initially, e.g., when the TD opted into having memory (e.g., crash) dumps.

In certain examples, the trust domain manager generates the VDK in the data structure 126. In certain examples, the trust domain manager communicates the decryption VDK to the TD dynamically, for example, using a symmetric key which is written into TD memory (e.g., pages) that are exclusively accessible by the TD. In certain examples, the symmetric key is used to decrypt the dump file, e.g., after all other workloads are removed from the system and/or only the TD authorized to enter debug mode is allowed to run. In certain examples, to be safe, the symmetric key is not be shared with the TD until after the other workloads (e.g., TDs) are dismantled and system is in debug mode.

In certain examples, an asymmetric private key is provisioned. In certain examples, an advantage of using an asymmetric key is, if the TD is using a hardware security module (HSM) for transportable keys, the VMM can map the HSM device into trust domain manager memory, provision the private key, and then disconnect the device. In certain examples, then the HSM may be switched to a different debug machine (e.g., separate from the production machine) before the debug mode can be utilized. In certain examples, the HSM could be a smart card (e.g., fob), such as, but not limited to, a common access card (CAC) or a Secure Element according to a Universal Serial Bus (USB) standard. In certain examples, the HSM is a rack scale sub-module that can be switched to a different server blade/rack that is designed for debugging purposes. In certain examples, the encrypted dump file can be moved across an unprotected bus, rack scale backplane, fabric, etc. without decryption.

In certain examples, a debugger runs in “debug mode” which is a mode of the processor (e.g., thread). In certain examples, the OS kernel and VMM control the transition to debug mode. Certain examples herein allow the trust domain manager to control (at least in part) the transition to debug mode. In one example, the setting up the VDK is a way of controlling access to debug mode, e.g., if TD is not authorized to debug, the trust domain manager would disallow registry of the VDK. In certain examples, VMM and OS transitions are controlled by the trust domain manager, e.g., by their asking the trust domain manger if a TD is authorized to enter debug mode(s) they manage.

In certain examples, a VDK (e.g., and a debug interface) are used to protect guest VM's (e.g., TD's) memory dump file, e.g., the VDK is (e.g., only) used to encrypt specific address space (e.g., for the runtime debug scenario).

In certain examples, a tenant can read one or more specific variable's value from guest VM memory space via Host-Host debug interface in production mode, e.g., where a VDK is used to encrypt target variable's memory space rather than the whole memory space. In certain examples, tenant can set (e.g., write) some variable's value via Host-Host debug interface in production mode, e.g., where the content to be written is encrypted with a VDK in the tenant's secure environment (e.g., the trust module will decrypt the encrypted content then set it to the target variable(s)).

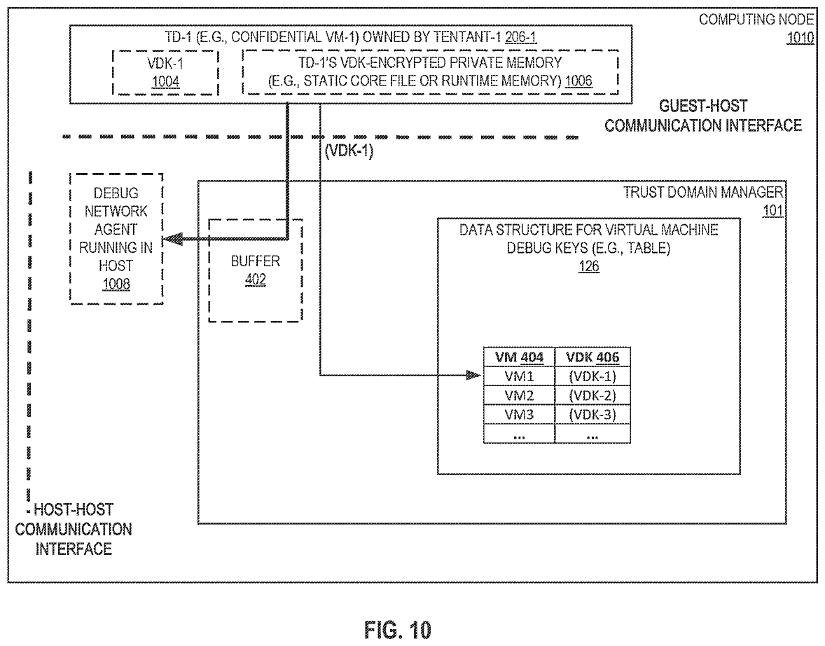

FIG. 10 is a block diagram including a trust domain 206-1 (e.g., confidential VM) that also functions as the debug agent for a tenant workload in the trust domain 206-1 (e.g., in tenant 1's secure environment) (for example, of computing node 1010) that is authorized to view a debug file 1006 and to debug the image encrypted by a VDK (e.g., VDK-1 for VM1) (e.g., on a system in debug mode) according to examples of the disclosure.

In certain examples, if the VDK for a VM (e.g., TD) is symmetric, the VDK (e.g., VDK-1 1004 for VDK-encrypted private memory 1006 of TD-1) is known to both guest-host VM (e.g., TD) and the trust domain manager (TDM) 101.

There are multiple ways to provision the symmetric key. (A) copy it into guest-host VM (e.g., TD) memory pages that are exclusively shared between guest-host VM (e.g., TD) and TDM, or (B) rely on a provisioning key (e.g., key encryption key (KEK)) where the symmetric key is wrapped by the KEK public key and decrypted by the private KEK. Either Guest or TDM could have the private key, e.g., and whichever has the private key is the one that decrypts, and the other side encrypts.

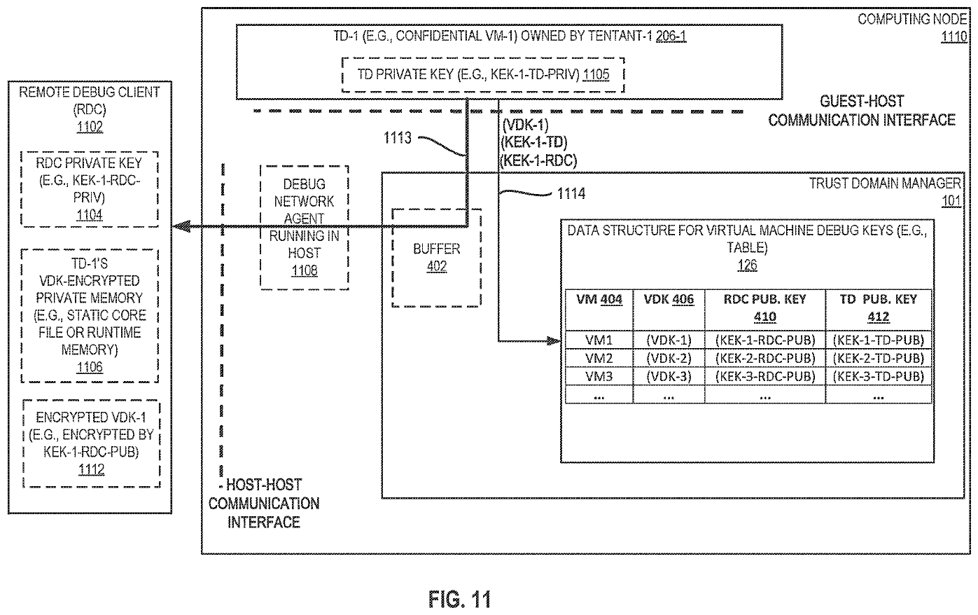

FIG. 11 is a block diagram of a remote debug client (RDC) 1102 (e.g., in tenant 1's secure environment) (for example, of computing node 1110, e.g., and a debug network agent 1108 running in host) (e.g., where the debug network agent 1108 is to forward the encrypted debug key 1112 (e.g., VDK) from the TDM) that is authorized to view a debug file 1106 from a guest-host VM (e.g., TD) and to decrypt an encrypted debug image using the VDK for decryption by the RDC 1102 (e.g., on a system in debug mode) according to examples of the disclosure.

In certain examples, as a prerequisite to RDC debugging, the RDC 1102 generates the debug image key encryption key (KEK) key pair where the private KEK (e.g., KEK-RDC-PRIV 1104) is used to decrypt the debug image encryption key (e.g., VDK 406) and the public KEK (e.g., KEK-RDC-PUB 410) is used to encrypt the debug image encryption key (e.g., VDK 406) by the trust domain manager 101. For example, if the debug image encryption key 406 (e.g., VDK-1) for a VM (e.g., TD) is symmetric, the private KEK key 1104 is presumed to be generated on the RDC 1102 and the public KEK key 410 is provisioned to the TDM 101). In certain examples, the KEK public key 410 is used to encrypt the debug image encryption key VDK 406 (e.g., VDK-1 for TD-1) which is further used to encrypt the debug image. In certain example, the RDC 1102 can decrypt the encrypted debug image using the VDK 406 after unwrapping it using the RDC private KEK 1104 (e.g., KEK-1-RDC-PRIV. in FIG. 11) (e.g., only the RDC 1102 can access the debug image as the KEK-1-RDC-PRIV key only exists on the RDC). In certain examples, the VDK is a symmetric key, then it is known to the trust domain manager (TDM) 101, and securely shared with designated debug clients (e.g., RDC 1102 and TD-1 206-1).

There are multiple ways to share the symmetric VDK 406. (A) copy it into guest-host VM 206-1 (e.g., TD) memory pages that are exclusively shared between the guest-host VM (e.g., TD) and TDM (101), (B) rely on a provisioning key (e.g., key encryption key (KEK) (e.g., 410 or 412)) where the symmetric key is wrapped by the KEK public key and decrypted by the private KEK. Either Guest or TDM could have the private key, e.g., and whichever has the private key is the one that decrypts, and the other side encrypts.

In certain examples (e.g., if an RDC is used), it needs to generate asymmetric KEK key pair (e.g., KEK-1-RDC-PUB public key and KEK-1-RDC-PRIV key as a pair for TD-1) and then provision the public key to the TDM 101. In certain examples, the guest-host VM (e.g., TD) should approve the possibility of an RDC debug entity. In certain examples, the public KEK (e.g., 410 or 412) is securely provisioned to the TDM 101 over a secure channel, such as, but not limited to, the Distributed Manageability Task Force (DMTF) Security Protocol and Data Model (SPDM) protocol or the Internet Engineering Task Force (IETF) Transport Layer Security (TLS) protocol applied to the path 1114 that connects VM 206-1 to the data structure 126 (e.g., TDM key table) or to the path 1113 that connects RDC 1102 to TD-1 206-1. In certain examples, the public KEK 410 is securely provisioned to guest-host VM (e.g., TD) first (for approval) then forwarded to TDM (e.g., they setup a TLS session before doing meaningful work in guest-host VM (e.g., TD)), e.g., the guest-host VM (e.g., TD) then provisions both VDK and KEK-PUB 410 (e.g., in data structure 126) into the TDM.

In certain examples, when a debug image is generated, the TDM has the option whether to encrypt the debug image using the VDK 406 or deliver the debug image over a secure channel, such as, but not limited to, SPDM or TLS. In certain examples, the TDM has the option of wrapping the VDK with the KEK (410 or 412, or both) and delivering the encrypted debug image 1106 and wrapped VDK image 1112 to the RDC, e.g., over an insecure channel. A policy can be configured that resolves which action the TDM should take.

In certain examples, the hardware beneath (e.g., “implementing”) the guest-host VM (e.g., TD) it to then transition into a debug mode, e.g., resulting in hardware access to debug (e.g., JTAG) ports. In certain examples, any other guest VMs (e.g., not experiencing failures) have been migrated off this platform as a pre-condition of it entering debug mode. In certain embodiments, operations include (1) fault detection in the guest-host VM (e.g., TD), (2) encrypting the guest-host VM (e.g., TD) debug image, (3) migration of other VMs to second/peer computer, (4) decision to debug on Guest-host VM or on RDC, (5) setup connection to RDC. (6) place the first computer into debug mode, (7) signal RDC to begin debugging, (8) RDC decrypts the debug image using KEK private key, and then (9) RDC accesses debug (e.g., JTAG) port(s), etc.

In certain examples, the RDC's 102 hardware is used to debug the debug image, e.g., where the RDC hardware enters a debug mode resulting in hardware access to debug (e.g., JTAG) ports, etc.

In certain examples, some of the guest-host VM (e.g., TD) pages can remain confidential (e.g., omitted from the debug image). In certain examples, the guest-host VM (e.g., TD) tenants may locate application specific secrets and privacy sensitive data in one or more of the “off limits” pages, e.g., and so of a fault occurs resulting in a debug image, the “off limits” pages would be excluded.

In certain examples, a policy authorizes the “off limits” pages to be included in the debug image for a local debug client (LDC) while remaining off limits for a RDC, e.g., where the RDC may be provided by a 3rd party who is not trusted to know secrets and privacy sensitive data while the guest-host VM (e.g., TD) already knows this information.

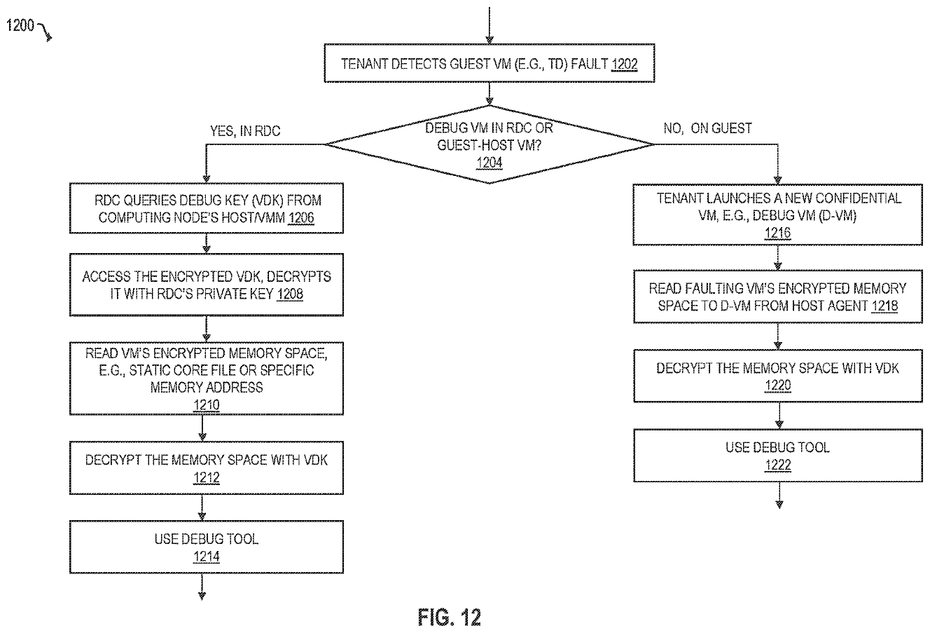

FIG. 12 is a flow diagram illustrating operations 1200 of a method for debugging a virtual machine's (e.g., trust domain's) private data according to examples of the disclosure. Some or all of the operations 1200 (or other processes described herein, or variations, and/or combinations thereof) are configured under the control of a trust domain manager (or other components discussed herein) as implemented herein and/or one or more computer systems (e.g., processors) configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 1200 are performed by trust domain manager 101 of the other figures.

The operations 1200 include, at block 1202, a tenant detects guest VM (e.g., TD) fault. The operations 1200 further include, at block 1204, checking whether to debug that guest VM (e.g., TD) in a remote debug client (RDC) or in the guest VM (e.g., TD). If yes, to debug in the RDC, then proceeding, at block 1206, to the RDC querying the debug key (e.g., VDK) from the computing node's HOST/VMM. The operations 1200 further include, at block 1208, accessing the encrypted VDK, and decrypting it with the RDC's private key (e.g., KEK-PRIV). The operations 1200 further include, at block 1210, reading the guest VM's (e.g., TD's) encrypted memory space, e.g., static core file or specific memory address. The operations 1200 further include, at block 1212, decrypting the memory space with the decrypted VDK. The operations 1200 further include, at block 1214, using a debug tool (e.g., GDM for Strace to check values) on the decrypted data. If no, to debug in the guest VM (e.g., TD), then proceeding, at block 1216, such that the tenant launches a new confidential VM, e.g., debug VM (D-VM). The operations 1200 further include, at block 1218, reading faulting VM's encrypted memory space to D-VM from host agent. The operations 1200 further include, at block 1220, decrypting the memory space with the VDK. The operations 1200 further include, at block 1222, using a debug tool (e.g., GDM for Strace to check values) on the decrypted data.

Exemplary architectures, systems, etc. that the above may be used in are detailed below. Exemplary instruction formats that may cause any of the operations herein are detailed below.

At least some examples of the disclosed technologies can be described in view of the following examples:
Example 1. An apparatus comprising:
a hardware processor core to implement:
   a trust domain manager to manage one or more hardware isolated virtual machines as a respective trust domain with a region of memory protected by a respective encryption key, and
   a virtual machine monitor that is not allowed access to the protected region of memory of the one or more hardware isolated virtual machines; and
a memory management circuit coupled between the hardware processor core and the memory,
wherein, in response to a hardware isolated virtual machine generating a memory dump file, the trust domain manager is to encrypt the memory dump file with a debug key that is different from any of the respective encryption key to generate an encrypted memory dump file, and store the encrypted memory dump file in a portion of the memory that is accessible by the virtual machine monitor.
Example 2. The apparatus of example 1, wherein the trust domain manager is to, in response to a request to create the hardware isolated virtual machine, generate the debug key and store the debug key into a data structure of the trust domain manager.
Example 3. The apparatus of example 2, wherein the data structure of the trust domain manager comprises a corresponding debug key to hardware isolated virtual machine mapping for each of a plurality of hardware isolated virtual machines.
Example 4. The apparatus of example 2, wherein the trust domain manager is to remove the debug key from the data structure of the trust domain manager in response to a request to destroy the hardware isolated virtual machine.
Example 5. The apparatus of example 1, wherein the trust domain manager is to, in response to the hardware isolated virtual machine generating the memory dump file:
   check, in a data structure comprising a debug key to hardware isolated virtual machine mapping, if the debug key exists for the hardware isolated virtual machine generating the memory dump file;
   if the debug key exists in the data structure, encrypt the memory dump file with the debug key and store the encrypted memory dump file in the portion of the memory that is accessible by the virtual machine monitor; and
   if the debug key does not exist in the data structure, return an indication of an error.
Example 6. The apparatus of example 1, wherein the trust domain manager is to, in response to a request to create the hardware isolated virtual machine, generate the debug key and store the debug key into a data structure of the trust domain manager when the hardware processor core is in a production mode.
Example 7. The apparatus of example 1, wherein the trust domain manager is to allow access to the debug key only by the trust domain manager and the hardware isolated virtual machine generating the memory dump file.
Example 8. The apparatus of any one of examples 1-7, wherein the hardware isolated virtual machine is to generate the memory dump file in response to a non-operating system application in the hardware isolated virtual machine crashing.
Example 9. A method comprising:
managing one or more hardware isolated virtual machines as a respective trust domain with a region of memory, protected by a respective encryption key, by a trust domain manager of a hardware processor core that also comprises a virtual machine monitor that is not allowed access to the protected region of memory of the one or more hardware isolated virtual machines;
encrypting a memory dump file, by the trust domain manager in response to a hardware isolated virtual machine generating the memory dump file, with a debug key that is different from any of the respective encryption key to generate an encrypted memory dump file; and
storing the encrypted memory dump file in a portion of the memory that is accessible by the virtual machine monitor.
Example 10. The method of example 9, further comprising:
   generating, by the trust domain manager in response to a request to create the hardware isolated virtual machine, the debug key; and
   storing the debug key into a data structure of the trust domain manager.
Example 11. The method of example 10, wherein the data structure of the trust domain manager comprises a corresponding debug key to hardware isolated virtual machine mapping for each of a plurality of hardware isolated virtual machines.
Example 12. The method of example 10, further comprising removing, by the trust domain manager, the debug key from the data structure of the trust domain manager in response to a request to destroy the hardware isolated virtual machine.
Example 13. The method of example 9, further comprising, in response to the hardware isolated virtual machine generating the memory dump file, the trust domain manager:
   checking, in a data structure comprising a debug key to hardware isolated virtual machine mapping, if the debug key exists for the hardware isolated virtual machine generating the memory dump file;
   if the debug key exists in the data structure, encrypting the memory dump file with the debug key and store the encrypted memory dump file in the portion of the memory that is accessible by the virtual machine monitor; and
   if the debug key does not exist in the data structure, returning an indication of an error.
Example 14. The method of example 9, further comprising:
   generating, by the trust domain manager in response to a request to create the hardware isolated virtual machine, the debug key; and
   storing the debug key into a data structure of the trust domain manager when the hardware processor core is in a production mode.
Example 15. The method of example 9, further comprising only allowing, by the trust domain manager, access to the debug key by the trust domain manager and the hardware isolated virtual machine generating the memory dump file.
Example 16. The method of any one of examples 9-15, further comprising generating, by the hardware isolated virtual machine, the memory dump file in response to a non-operating system application in the hardware isolated virtual machine crashing.
Example 17. An apparatus comprising:
a memory;
a hardware processor core to implement:
   a trust domain manager to manage one or more hardware isolated virtual machines as a respective trust domain with a region of memory protected by a respective encryption key, and
   a virtual machine monitor that is not allowed access to the protected region of memory of the one or more hardware isolated virtual machines; and
a memory management circuit coupled between the hardware processor core and the memory,
wherein, in response to a hardware isolated virtual machine generating a memory dump file, the trust domain manager is to encrypt the memory dump file with a debug key that is different from any of the respective encryption key to generate an encrypted memory dump file, and store the encrypted memory dump file in a portion of the memory that is accessible by the virtual machine monitor.
Example 18. The apparatus of example 17, wherein the trust domain manager is to, in response to a request to create the hardware isolated virtual machine, generate the debug key and store the debug key into a data structure of the trust domain manager.
Example 19. The apparatus of example 18, wherein the data structure of the trust domain manager comprises a corresponding debug key to hardware isolated virtual machine mapping for each of a plurality of hardware isolated virtual machines.
Example 20. The apparatus of example 18, wherein the trust domain manager is to remove the debug key from the data structure of the trust domain manager in response to a request to destroy the hardware isolated virtual machine.
Example 21. The apparatus of example 17, wherein the trust domain manager is to, in response to the hardware isolated virtual machine generating the memory dump file:
   check, in a data structure comprising a debug key to hardware isolated virtual machine mapping, if the debug key exists for the hardware isolated virtual machine generating the memory dump file;
   if the debug key exists in the data structure, encrypt the memory dump file with the debug key and store the encrypted memory dump file in the portion of the memory that is accessible by the virtual machine monitor; and
   if the debug key does not exist in the data structure, return an indication of an error.
Example 22. The apparatus of example 17, wherein the trust domain manager is to, in response to a request to create the hardware isolated virtual machine, generate the debug key and store the debug key into a data structure of the trust domain manager when the hardware processor core is in a production mode.
Example 23. The apparatus of example 17, wherein the trust domain manager is to allow access to the debug key only by the trust domain manager and the hardware isolated virtual machine generating the memory dump file.
Example 24. The apparatus of any one of examples 17-23, wherein the hardware isolated virtual machine is to generate the memory dump file in response to a non-operating system application in the hardware isolated virtual machine crashing.

### Example Computer Architectures.

Detailed below are descriptions of example computer architectures. Other system designs and configurations known in the arts for laptop, desktop, and handheld personal computers.

(PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

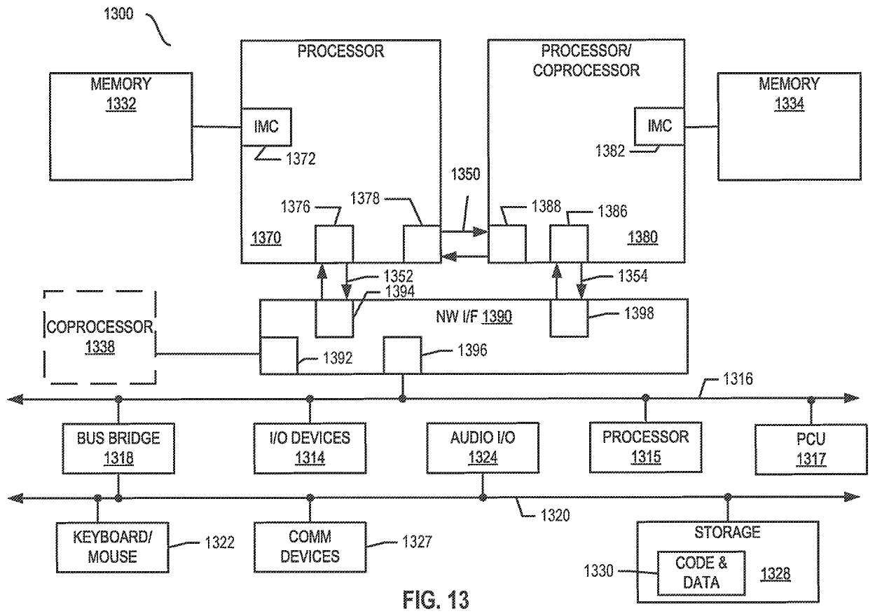

FIG. 13 illustrates an example computing system. Multiprocessor system 1300 is an interfaced system and includes a plurality of processors or cores including a first processor 1370 and a second processor 1380 coupled via an interface 1350 such as a point-to-point (P-P) interconnect, a fabric, and/or bus. In some examples, the first processor 1370 and the second processor 1380 are homogeneous. In some examples, the first processor 1370 and the second processor 1380 are heterogenous. Though the example system 1300 is shown to have two processors, the system may have three or more processors, or may be a single processor system. In some examples, the computing system is a system on a chip (SoC).

Processors 1370 and 1380 are shown including integrated memory controller (IMC) circuitry 1372 and 1382, respectively. Processor 1370 also includes interface circuits 1376 and 1378; similarly, second processor 1380 includes interface circuits 1386 and 1388. Processors 1370, 1380 may exchange information via the interface 1350 using interface circuits 1378, 1388. IMCs 1372 and 1382 couple the processors 1370, 1380 to respective memories, namely a memory 1332 and a memory 1334, which may be portions of main memory locally attached to the respective processors.

Processors 1370, 1380 may each exchange information with a network interface (NW I/F) 1390 via individual interfaces 1352, 1354 using interface circuits 1376, 1394, 1386, 1398. The network interface 1390 (e.g., one or more of an interconnect, bus, and/or fabric, and in some examples is a chipset) may optionally exchange information with a coprocessor 1338 via an interface circuit 1392. In some examples, the coprocessor 1338 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1370, 1380 or outside of both processors, yet connected with the processors via an interface such as P-P interconnect, such that either or both processors' local cache information may be stored in the shared cache if a processor is placed into a low power mode.

Network interface 1390 may be coupled to a first interface 1316 via interface circuit 1396. In some examples, first interface 1316 may be an interface such as a Peripheral Component Interconnect (PCI) interconnect, a PCI Express interconnect or another I/O interconnect. In some examples, first interface 1316 is coupled to a power control unit (PCU) 1317, which may include circuitry, software, and/or firmware to perform power management operations with regard to the processors 1370, 1380 and/or co-processor 1338. PCU 1317 provides control information to a voltage regulator (not shown) to cause the voltage regulator to generate the appropriate regulated voltage. PCU 1317 also provides control information to control the operating voltage generated. In various examples, PCU 1317 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1317 is illustrated as being present as logic separate from the processor 1370 and/or processor 1380. In other cases, PCU 1317 may execute on a given one or more of cores (not shown) of processor 1370 or 1380. In some cases, PCU 1317 may be implemented as a microcontroller (dedicated or general-purpose) or other control logic configured to execute its own dedicated power management code, sometimes referred to as P-code. In yet other examples, power management operations to be performed by PCU 1317 may be implemented externally to a processor, such as by way of a separate power management integrated circuit (PMIC) or another component external to the processor. In yet other examples, power management operations to be performed by PCU 1317 may be implemented within BIOS or other system software.

Various I/O devices 1314 may be coupled to first interface 1316, along with a bus bridge 1318 which couples first interface 1316 to a second interface 1320. In some examples, one or more additional processor(s) 1315, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1316. In some examples, second interface 1320 may be a low pin count (LPC) interface. Various devices may be coupled to second interface 1320 including, for example, a keyboard and/or mouse 1322, communication devices 1327 and storage circuitry 1328. Storage circuitry 1328 may be one or more non-transitory machine-readable storage media as described below, such as a disk drive or other mass storage device which may include instructions/code and data 1330 and may implement the storage ‘ISAB03 in some examples. Further, an audio I/O 1324 may be coupled to second interface 1320. Note that other architectures than the point-to-point architecture described above are possible. For example, instead of the point-to-point architecture, a system such as multiprocessor system 1300 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

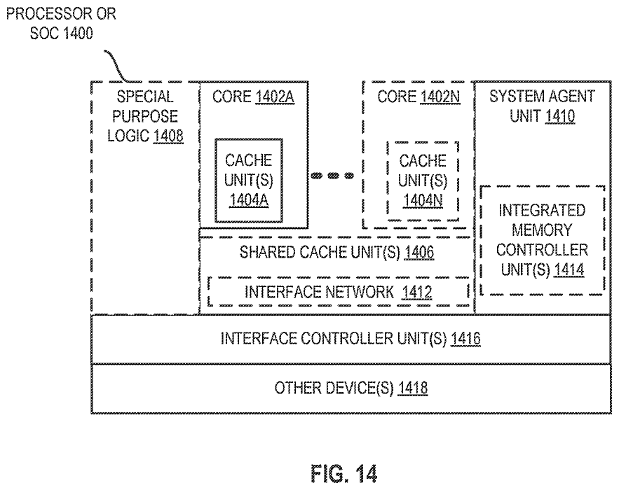

FIG. 14 illustrates a block diagram of an example processor and/or SoC 1400 that may have one or more cores and an integrated memory controller. The solid lined boxes illustrate a processor 1400 with a single core 1402A, system agent unit circuitry 1410, and a set of one or more interface controller unit(s) circuitry 1416, while the optional addition of the dashed lined boxes illustrates an alternative processor 1400 with multiple cores 1402A-N, a set of one or more integrated memory controller unit(s) circuitry 1414 in the system agent unit circuitry 1410, and special purpose logic 1408, as well as a set of one or more interface controller units circuitry 1416. Note that the processor 1400 may be one of the processors 1370 or 1380, or co-processor 1338 or 1315 of FIG. 13.

Thus, different implementations of the processor 1400 may include: 1) a CPU with the special purpose logic 1408 being integrated graphics and/or scientific (throughput) logic (which may include one or more cores, not shown), and the cores 1402A-N being one or more general purpose cores (e.g., general purpose in-order cores, general purpose out-of-order cores, or a combination of the two); 2) a coprocessor with the cores 1402A-N being a large number of special purpose cores intended primarily for graphics and/or scientific (throughput); and 3) a coprocessor with the cores 1402A-N being a large number of general purpose in-order cores. Thus, the processor 1400 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1400 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1404A-N within the cores 1402A-N, a set of one or more shared cache unit(s) circuitry 1406, and external memory (not shown) coupled to the set of integrated memory controller unit(s) circuitry 1414. The set of one or more shared cache unit(s) circuitry 1406 may include one or more mid-level caches, such as level 2 (L2), level 3 (L3), level 4 (L4), or other levels of cache, such as a last level cache (LLC), and/or combinations thereof. While in some examples interface network circuitry 1412 (e.g., a ring interconnect) interfaces the special purpose logic 1408 (e.g., integrated graphics logic), the set of shared cache unit(s) circuitry 1406, and the system agent unit circuitry 1410, alternative examples use any number of well-known techniques for interfacing such units. In some examples, coherency is maintained between one or more of the shared cache unit(s) circuitry 1406 and cores 1402A-N. In some examples, interface controller units circuitry 1416 couple the cores 1402 to one or more other devices 1418 such as one or more I/O devices, storage, one or more communication devices (e.g., wireless networking, wired networking, etc.), etc.

In some examples, one or more of the cores 1402A-N are capable of multi-threading. The system agent unit circuitry 1410 includes those components coordinating and operating cores 1402A-N. The system agent unit circuitry 1410 may include, for example, power control unit (PCU) circuitry and/or display unit circuitry (not shown). The PCU may be or may include logic and components needed for regulating the power state of the cores 1402A-N and/or the special purpose logic 1408 (e.g., integrated graphics logic). The display unit circuitry is for driving one or more externally connected displays.

The cores 1402A-N may be homogenous in terms of instruction set architecture (ISA). Alternatively, the cores 1402A-N may be heterogeneous in terms of ISA; that is, a subset of the cores 1402A-N may be capable of executing an ISA, while other cores may be capable of executing only a subset of that ISA or another ISA.

Example Core Architectures-In-order and out-of-order core block diagram.

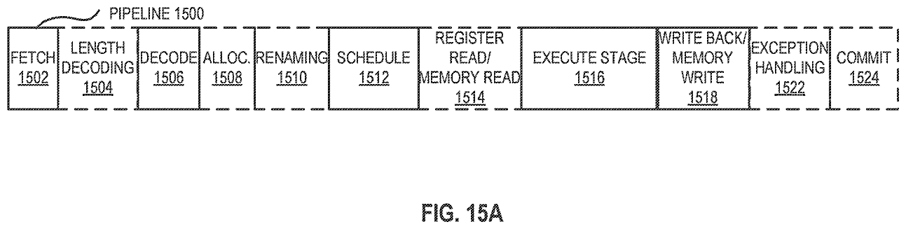

FIG. 15A is a block diagram illustrating both an example in-order pipeline and an example register renaming, out-of-order issue/execution pipeline according to examples. FIG. 15B is a block diagram illustrating both an example in-order architecture core and an example register renaming, out-of-order issue/execution architecture core to be included in a processor according to examples. The solid lined boxes in FIGS. 15A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 15A, a processor pipeline 1500 includes a fetch stage 1502, an optional length decoding stage 1504, a decode stage 1506, an optional allocation (Alloc) stage 1508, an optional renaming stage 1510, a schedule (also known as a dispatch or issue) stage 1512, an optional register read/memory read stage 1514, an execute stage 1516, a write back/memory write stage 1518, an optional exception handling stage 1522, and an optional commit stage 1524. One or more operations can be performed in each of these processor pipeline stages. For example, during the fetch stage 1502, one or more instructions are fetched from instruction memory, and during the decode stage 1506, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1506 and the register read/memory read stage 1514 may be combined into one pipeline stage. In one example, during the execute stage 1516, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 15B may implement the pipeline 1500 as follows: 1) the instruction fetch circuitry 1538 performs the fetch and length decoding stages 1502 and 1504; 2) the decode circuitry 1540 performs the decode stage 1506; 3) the rename/allocator unit circuitry 1552 performs the allocation stage 1508 and renaming stage 1510; 4) the scheduler(s) circuitry 1556 performs the schedule stage 1512; 5) the physical register file(s) circuitry 1558 and the memory unit circuitry 1570 perform the register read/memory read stage 1514; the execution cluster(s) 1560 perform the execute stage 1516; 6) the memory unit circuitry 1570 and the physical register file(s) circuitry 1558 perform the write back/memory write stage 1518; 7) various circuitry may be involved in the exception handling stage 1522; and 8) the retirement unit circuitry 1554 and the physical register file(s) circuitry 1558 perform the commit stage 1524.

FIG. 15B shows a processor core 1590 including front-end unit circuitry 1530 coupled to execution engine unit circuitry 1550, and both are coupled to memory unit circuitry 1570. The core 1590 may be a reduced instruction set architecture computing (RISC) core, a complex instruction set architecture computing (CISC) core, a very long instruction word (VLIW) core, or a hybrid or alternative core type. As yet another option, the core 1590 may be a special-purpose core, such as, for example, a network or communication core, compression engine, coprocessor core, general purpose computing graphics processing unit (GPGPU) core, graphics core, or the like.

The front-end unit circuitry 1530 may include branch prediction circuitry 1532 coupled to instruction cache circuitry 1534, which is coupled to an instruction translation lookaside buffer (TLB) 1536, which is coupled to instruction fetch circuitry 1538, which is coupled to decode circuitry 1540. In one example, the instruction cache circuitry 1534 is included in the memory unit circuitry 1570 rather than the front-end circuitry 1530. The decode circuitry 1540 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1540 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1540 may be implemented using various different mechanisms. Examples of suitable mechanisms include, but are not limited to, look-up tables, hardware implementations, programmable logic arrays (PLAs), microcode read only memories (ROMs), etc. In one example, the core 1590 includes a microcode ROM (not shown) or other medium that stores microcode for certain macroinstructions (e.g., in decode circuitry 1540 or otherwise within the front-end circuitry 1530). In one example, the decode circuitry 1540 includes a micro-operation (micro-op) or operation cache (not shown) to hold/cache decoded operations, micro-tags, or micro-operations generated during the decode or other stages of the processor pipeline 1500. The decode circuitry 1540 may be coupled to rename/allocator unit circuitry 1552 in the execution engine circuitry 1550.

The execution engine circuitry 1550 includes the rename/allocator unit circuitry 1552 coupled to retirement unit circuitry 1554 and a set of one or more scheduler(s) circuitry 1556. The scheduler(s) circuitry 1556 represents any number of different schedulers, including reservations stations, central instruction window, etc. In some examples, the scheduler(s) circuitry 1556 can include arithmetic logic unit (ALU) scheduler/scheduling circuitry, ALU queues, address generation unit (AGU) scheduler/scheduling circuitry, AGU queues, etc. The scheduler(s) circuitry 1556 is coupled to the physical register file(s) circuitry 1558. Each of the physical register file(s) circuitry 1558 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1558 includes vector registers unit circuitry, writemask registers unit circuitry, and scalar register unit circuitry. These register units may provide architectural vector registers, vector mask registers, general-purpose registers, etc. The physical register file(s) circuitry 1558 is coupled to the retirement unit circuitry 1554 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1554 and the physical register file(s) circuitry 1558 are coupled to the execution cluster(s) 1560. The execution cluster(s) 1560 includes a set of one or more execution unit(s) circuitry 1562 and a set of one or more memory access circuitry 1564. The execution unit(s) circuitry 1562 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1556, physical register file(s) circuitry 1558, and execution cluster(s) 1560 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 1564). It should also be understood that where separate pipelines are used, one or more of these pipelines may be out-of-order issue/execution and the rest in-order.

In some examples, the execution engine unit circuitry 1550 may perform load store unit (LSU) address/data pipelining to an Advanced Microcontroller Bus (AMB) interface (not shown), and address phase and writeback, data phase load, store, and branches.

The set of memory access circuitry 1564 is coupled to the memory unit circuitry 1570, which includes data TLB circuitry 1572 coupled to data cache circuitry 1574 coupled to level 2 (L2) cache circuitry 1576. In one example, the memory access circuitry 1564 may include load unit circuitry, store address unit circuitry, and store data unit circuitry, each of which is coupled to the data TLB circuitry 1572 in the memory unit circuitry 1570. The instruction cache circuitry 1534 is further coupled to the level 2 (L2) cache circuitry 1576 in the memory unit circuitry 1570. In one example, the instruction cache 1534 and the data cache 1574 are combined into a single instruction and data cache (not shown) in L2 cache circuitry 1576, level 3 (L3) cache circuitry (not shown), and/or main memory. The L2 cache circuitry 1576 is coupled to one or more other levels of cache and eventually to a main memory.

The core 1590 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1590 includes logic to support a packed data instruction set architecture extension (e.g., AVX1, AVX2), thereby allowing the operations used by many multimedia applications to be performed using packed data.

### Example Execution Unit(s) Circuitry.

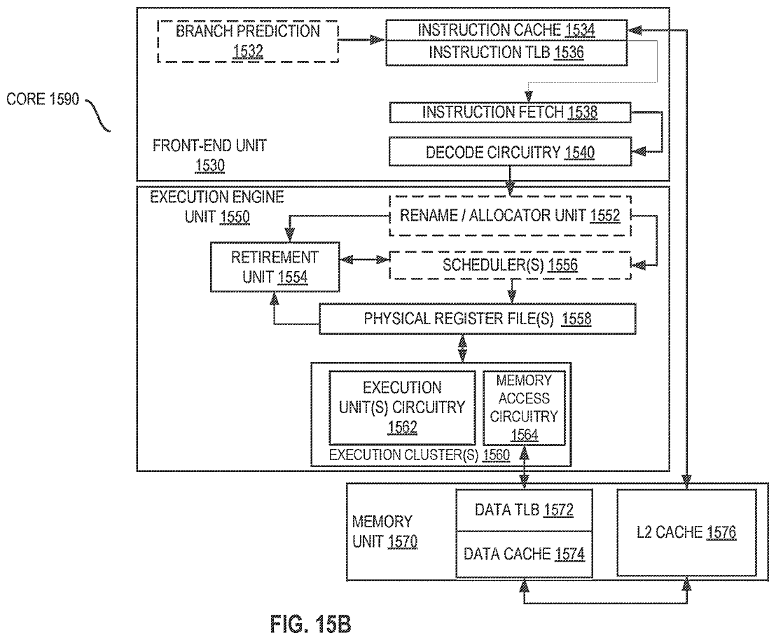

FIG. 16 illustrates examples of execution unit(s) circuitry, such as execution unit(s) circuitry 1562 of FIG. 15B. As illustrated, execution unit(s) circuitry 1562 may include one or more ALU circuits 1601, optional vector/single instruction multiple data (SIMD) circuits 1603, load/store circuits 1605, branch/jump circuits 1607, and/or Floating-point unit (FPU) circuits 1609. ALU circuits 1601 perform integer arithmetic and/or Boolean operations. Vector/SIMD circuits 1603 perform vector/SIMD operations on packed data (such as SIMD/vector registers). Load/store circuits 1605 execute load and store instructions to load data from memory into registers or store from registers to memory. Load/store circuits 1605 may also generate addresses. Branch/jump circuits 1607 cause a branch or jump to a memory address depending on the instruction. FPU circuits 1609 perform floating-point arithmetic. The width of the execution unit(s) circuitry 1562 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

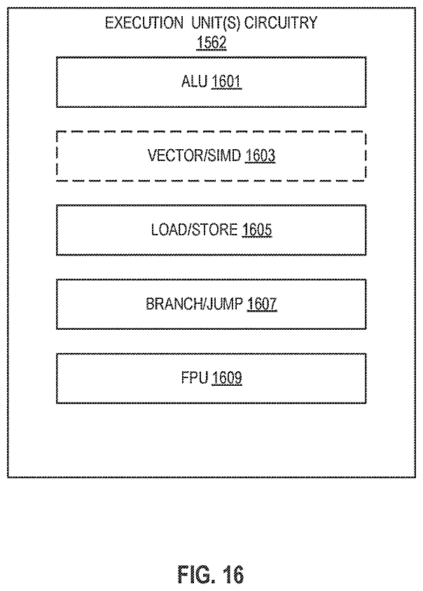

FIG. 17 is a block diagram of a register architecture 1700 according to some examples. As illustrated, the register architecture 1700 includes vector/SIMD registers 1710 that vary from 128-bit to 1,024 bits width. In some examples, the vector/SIMD registers 1710 are physically 512-bits and, depending upon the mapping, only some of the lower bits are used. For example, in some examples, the vector/SIMD registers 1710 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1700 includes writemask/predicate registers 1715. For example, in some examples, there are 8 writemask/predicate registers (sometimes called k0 through k7) that are each 16-bit, 32-bit. 64-bit, or 128-bit in size. Writemask/predicate registers 1715 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1715 corresponds to a data element position of the destination. In other examples, the writemask/predicate registers 1715 are scalable and consists of a set number of enable bits for a given vector element (e.g., 8 enable bits per 64-bit vector element).

The register architecture 1700 includes a plurality of general-purpose registers 1725. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1700 includes scalar floating-point (FP) register file 1745 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1740 (e.g., EFLAGS, RFLAGS, etc.) store status and control information for arithmetic, compare, and system operations. For example, the one or more flag registers 1740 may store condition code information such as carry, parity, auxiliary carry, zero, sign, and overflow. In some examples, the one or more flag registers 1740 are called program status and control registers.

Segment registers 1720 contain segment points for use in accessing memory. In some examples, these registers are referenced by the names CS, DS, SS, ES, FS, and GS.

Machine specific registers (MSRs) 1735 control and report on processor performance. Most MSRs 1735 handle system-related functions and are not accessible to an application program. Machine check registers 1760 consist of control, status, and error reporting MSRs that are used to detect and report on hardware errors.

One or more instruction pointer register(s) 1730 store an instruction pointer value. Control register(s) 1755 (e.g., CR0-CR4) determine the operating mode of a processor (e.g., processor 1370, 1380, 1338, 1315, and/or 1400) and the characteristics of a currently executing task. Debug registers 1750 control and allow for the monitoring of a processor or core's debugging operations.

Memory (mem) management registers 1765 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1700 may, for example, be used in register file/memory ‘ISAB08, or physical register file(s) circuitry 15 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source 1/destination and source 2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

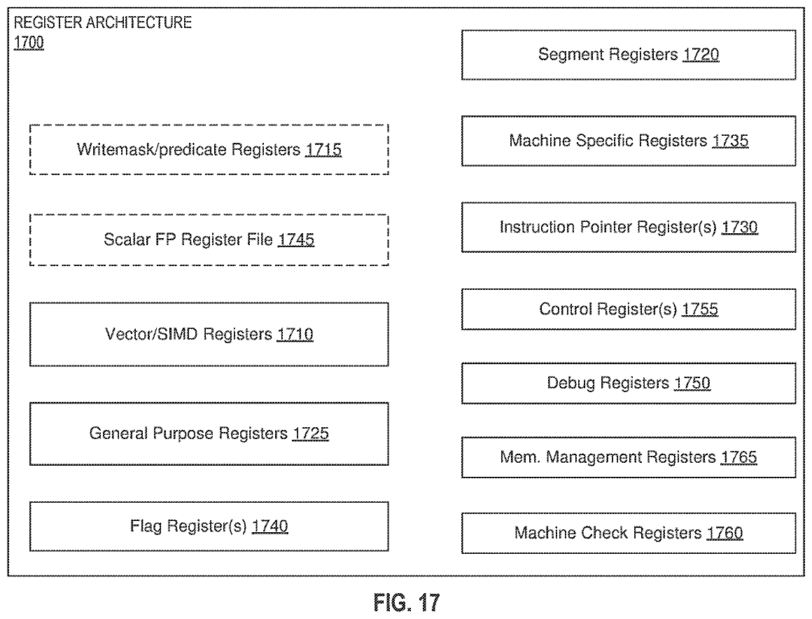

FIG. 18 illustrates examples of an instruction format. As illustrated, an instruction may include multiple components including, but not limited to, one or more fields for: one or more prefixes 1801, an opcode 1803, addressing information 1805 (e.g., register identifiers, memory addressing information, etc.), a displacement value 1807, and/or an immediate value 1809. Note that some instructions utilize some or all the fields of the format whereas others may only use the field for the opcode 1803. In some examples, the order illustrated is the order in which these fields are to be encoded, however, it should be appreciated that in other examples these fields may be encoded in a different order, combined, etc.

The prefix(es) field(s) 1801, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1803 is used to at least partially define the operation to be performed upon a decoding of the instruction. In some examples, a primary opcode encoded in the opcode field 1803 is one, two, or three bytes in length. In other examples, a primary opcode can be a different length. An additional 3-bit opcode field is sometimes encoded in another field.

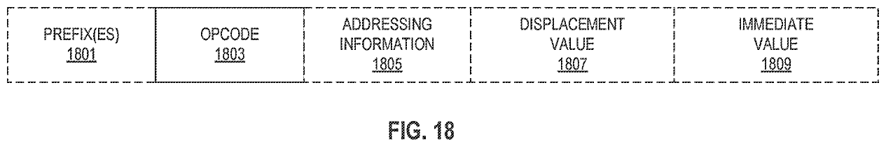

The addressing information field 1805 is used to address one or more operands of the instruction, such as a location in memory or one or more registers. FIG. 19 illustrates examples of the addressing information field 1805. In this illustration, an optional MOD R/M byte 1902 and an optional Scale, Index, Base (SIB) byte 1904 are shown. The MOD R/M byte 1902 and the SIB byte 1904 are used to encode up to two operands of an instruction, each of which is a direct register or effective memory address. Note that both of these fields are optional in that not all instructions include one or more of these fields. The MOD R/M byte 1902 includes a MOD field 1942, a register (reg) field 1944, and R/M field 1946.

The content of the MOD field 1942 distinguishes between memory access and non-memory access modes. In some examples, when the MOD field 1942 has a binary value of 11 (11b), a register-direct addressing mode is utilized, and otherwise a register-indirect addressing mode is used.

The register field 1944 may encode either the destination register operand or a source register operand or may encode an opcode extension and not be used to encode any instruction operand. The content of register field 1944, directly or through address generation, specifies the locations of a source or destination operand (either in a register or in memory). In some examples, the register field 1944 is supplemented with an additional bit from a prefix (e.g., prefix 1801) to allow for greater addressing.

The R/M field 1946 may be used to encode an instruction operand that references a memory address or may be used to encode either the destination register operand or a source register operand. Note the R/M field 1946 may be combined with the MOD field 1942 to dictate an addressing mode in some examples.

The SIB byte 1904 includes a scale field 1952, an index field 1954, and a base field 1956 to be used in the generation of an address. The scale field 1952 indicates a scaling factor. The index field 1954 specifies an index register to use. In some examples, the index field 1954 is supplemented with an additional bit from a prefix (e.g., prefix 1801) to allow for greater addressing. The base field 1956 specifies a base register to use. In some examples, the base field 1956 is supplemented with an additional bit from a prefix (e.g., prefix 1801) to allow for greater addressing. In practice, the content of the scale field 1952 allows for the scaling of the content of the index field 1954 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1807 provides this value. Additionally, in some examples, a displacement factor usage is encoded in the MOD field of the addressing information field 1805 that indicates a compressed displacement scheme for which a displacement value is calculated and stored in the displacement field 1807.

In some examples, the immediate value field 1809 specifies an immediate value for the instruction. An immediate value may be encoded as a 1-byte value, a 2-byte value, a 4-byte value, etc.

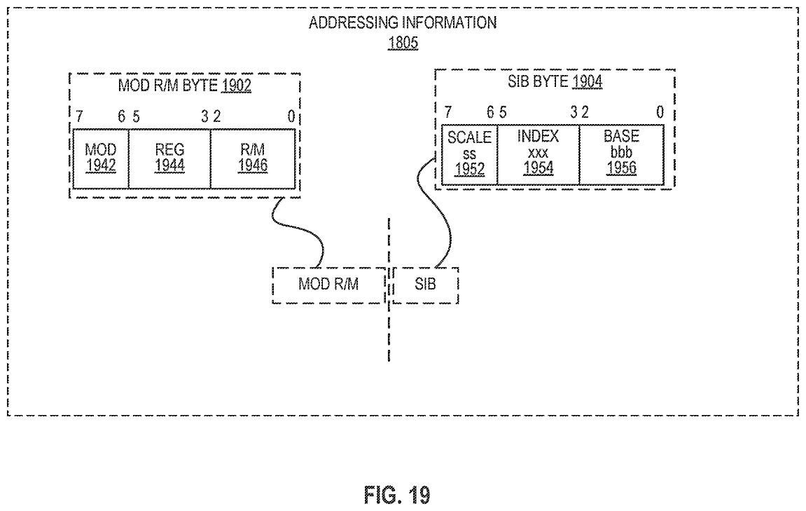

FIG. 20 illustrates examples of a first prefix 1801A. In some examples, the first prefix 1801A is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1801A may specify up to three registers using 3-bit fields depending on the format: 1) using the reg field 1944 and the R/M field 1946 of the MOD R/M byte 1902; 2) using the MOD R/M byte 1902 with the SIB byte 1904 including using the reg field 1944 and the base field 1956 and index field 1954; or 3) using the register field of an opcode.

In the first prefix 1801A, bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1944 and MOD R/M R/M field 1946 alone can each only address 8 registers.

In the first prefix 1801A, bit position 2 (R) may be an extension of the MOD R/M reg field 1944 and may be used to modify the MOD R/M reg field 1944 when that field encodes a general-purpose register, a 64-bit packed data register (e.g., an SSE register), or a control or debug register. R is ignored when MOD R/M byte 1902 specifies other registers or defines an extended opcode.

Bit position 1 (X) may modify the SIB byte index field 1954.

Bit position 0 (B) may modify the base in the MOD R/M R/M field 1946 or the SIB byte base field 1956; or it may modify the opcode register field used for accessing general purpose registers (e.g., general purpose registers 1725).

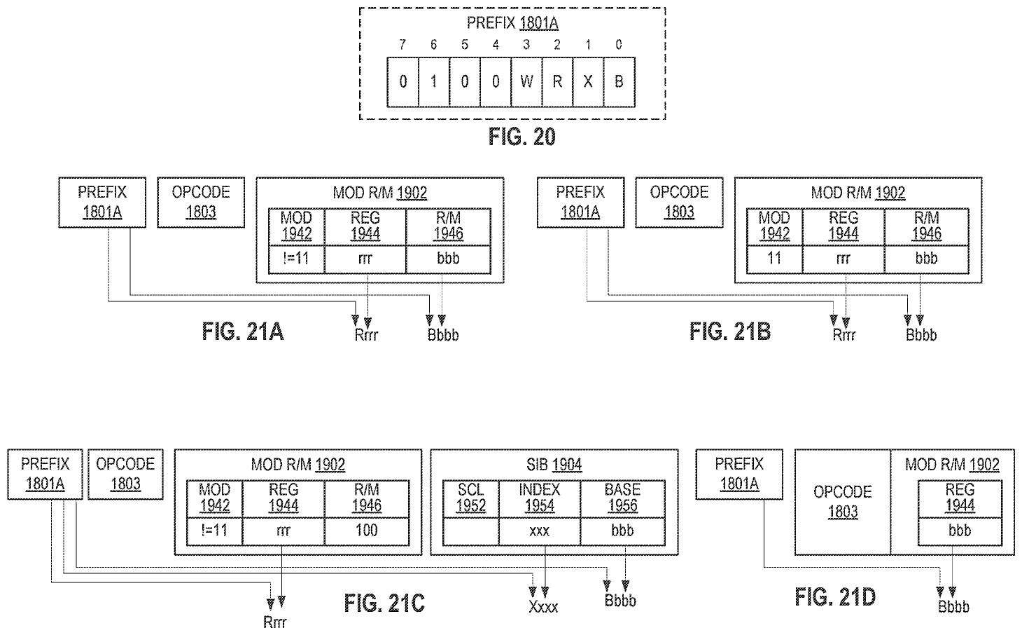

FIGS. 21A-D illustrate examples of how the R, X, and B fields of the first prefix 1801A are used. FIG. 21A illustrates R and B from the first prefix 1801A being used to extend the reg field 1944 and R/M field 1946 of the MOD R/M byte 1902 when the SIB byte 1904 is not used for memory addressing. FIG. 21B illustrates R and B from the first prefix 1801A being used to extend the reg field 1944 and R/M field 1946 of the MOD R/M byte 1902 when the SIB byte 1904 is not used (register-register addressing). FIG. 21C illustrates R, X, and B from the first prefix 1801A being used to extend the reg field 1944 of the MOD R/M byte 1902 and the index field 1954 and base field 1956 when the SIB byte 1904 being used for memory addressing. FIG. 21D illustrates B from the first prefix 1801A being used to extend the reg field 1944 of the MOD R/M byte 1902 when a register is encoded in the opcode 1803.

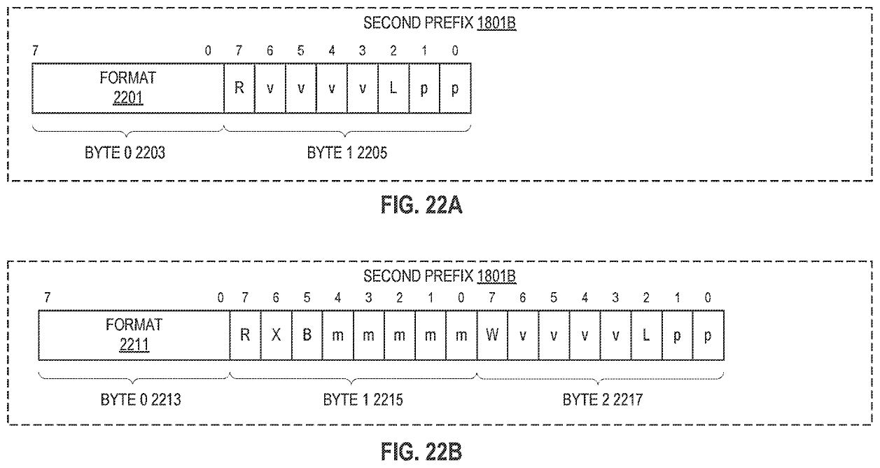

FIGS. 22A-B illustrate examples of a second prefix 1801B. In some examples, the second prefix 1801B is an example of a VEX prefix. The second prefix 1801B encoding allows instructions to have more than two operands, and allows SIMD vector registers (e.g., vector/SIMD registers 1710) to be longer than 64-bits (e.g., 128-bit and 256-bit). The use of the second prefix 1801B provides for three-operand (or more) syntax. For example, previous two-operand instructions performed operations such as A=A+B, which overwrites a source operand. The use of the second prefix 1801B enables operands to perform nondestructive operations such as A=B+C.

In some examples, the second prefix 1801B comes in two forms—a two-byte form and a three-byte form. The two-byte second prefix 1801B is used mainly for 128-bit, scalar, and some 256-bit instructions; while the three-byte second prefix 1801B provides a compact replacement of the first prefix 1801A and 3-byte opcode instructions.

FIG. 22A illustrates examples of a two-byte form of the second prefix 1801B. In one example, a format field 2201 (byte 0 2203) contains the value C5H. In one example, byte 1 2205 includes an “R” value in bit [7]. This value is the complement of the “R” value of the first prefix 1801A. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1946 to encode the instruction operand that references a memory address or encode either the destination register operand or a source register operand.

Instructions that use this prefix may use the MOD R/M reg field 1944 to encode either the destination register operand or a source register operand, or to be treated as an opcode extension and not used to encode any instruction operand.

For instruction syntax that support four operands, vvvv, the MOD R/M R/M field 1946 and the MOD R/M reg field 1944 encode three of the four operands. Bits [7:4] of the immediate value field 1809 are then used to encode the third source register operand.

FIG. 22B illustrates examples of a three-byte form of the second prefix 1801B. In one example, a format field 2211 (byte 0 2213) contains the value C4H. Byte 1 2215 includes in bits [7:5] “R.” “X.” and “B” which are the complements of the same values of the first prefix 1801A. Bits [4:0] of byte 1 2215 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit [7] of byte 2 2217 is used similar to W of the first prefix 1801A including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix. 01=66H, 10=F3H, and 11=F2H). Bits [6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1946 to encode the instruction operand that references a memory address or encode either the destination register operand or a source register operand.

Instructions that use this prefix may use the MOD R/M reg field 1944 to encode either the destination register operand or a source register operand, or to be treated as an opcode extension and not used to encode any instruction operand.

For instruction syntax that support four operands, vvvv, the MOD R/M R/M field 1946, and the MOD R/M reg field 1944 encode three of the four operands. Bits [7:4] of the immediate value field 1809 are then used to encode the third source register operand.

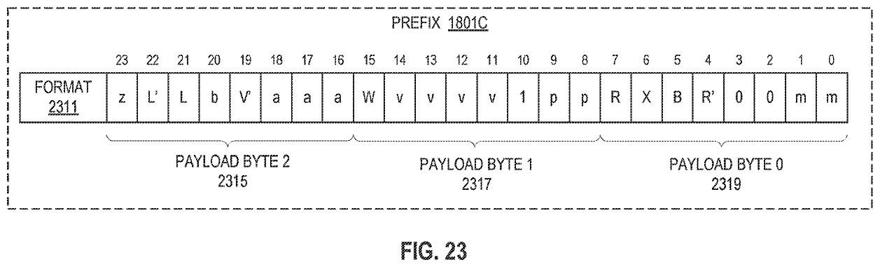

FIG. 23 illustrates examples of a third prefix 1801C. In some examples, the third prefix 1801C is an example of an EVEX prefix. The third prefix 1801C is a four-byte prefix.

The third prefix 1801C can encode 32 vector registers (e.g., 128-bit, 256-bit, and 512-bit registers) in 64-bit mode. In some examples, instructions that utilize a writemask/opmask (see discussion of registers in a previous figure, such as FIG. 17) or predication utilize this prefix. Opmask register allow for conditional processing or selection control. Opmask instructions, whose source/destination operands are opmask registers and treat the content of an opmask register as a single value, are encoded using the second prefix 1801B.

The third prefix 1801C may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1801C is a format field 2311 that has a value, in one example, of 62H. Subsequent bytes are referred to as payload bytes 2315-2319 and collectively form a 24-bit value of P[23:0] providing specific capability in the form of one or more fields (detailed herein).

In some examples, P[1:0] of payload byte 2319 are identical to the low two mm bits. P[3:2] are reserved in some examples. Bit P[4] (R′) allows access to the high 16 vector register set when combined with P[7] and the MOD R/M reg field 1944. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1944 and MOD R/M R/M field 1946. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1801A and second prefix 1811B and may serve as an opcode extension bit or operand size promotion.

P[18:16] specify the index of a register in the opmask (writemask) registers (e.g., writemask/predicate registers 1715). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1801C are detailed in the following tables.

TABLE 1
32-Register Support in 64-bit Mode

| | | | | REG. | |
|---|---|---|---|---|---|
| | 4 | 3 | [2:0] | TYPE | COMMON USAGES |
| REG | R′ | R | MOD R/M | GPR, | Destination or Source |
| | | | reg | Vector | |
| VVVV | V′ | vvvv | | GPR, | 2nd Source or Destination |
| | | | | Vector | |
| RM | X | B | MOD R/M | GPR, | 1st Source or Destination |
| | | | R/M | Vector | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

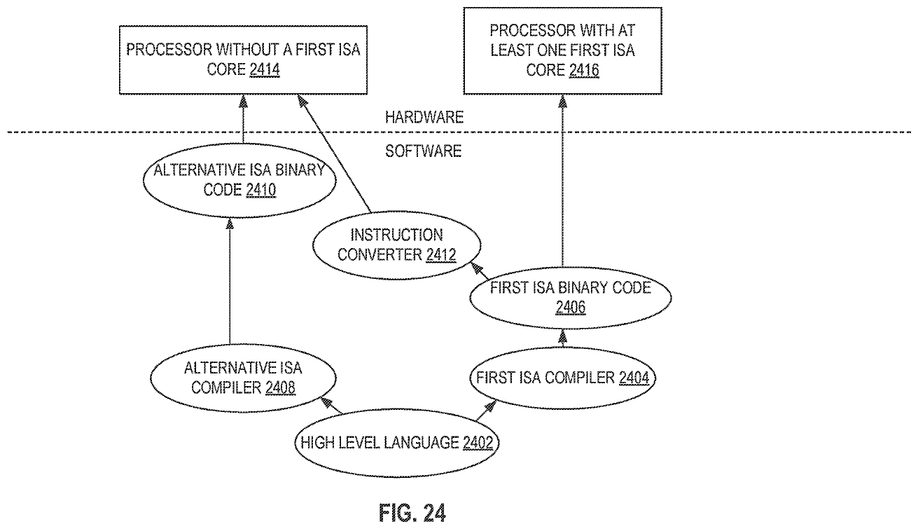

FIG. 24 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 24 shows a program in a high-level language 2402 may be compiled using a first ISA compiler 2404 to generate first ISA binary code 2406 that may be natively executed by a processor with at least one first ISA core 2416. The processor with at least one first ISA core 2416 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2404 represents a compiler that is operable to generate first ISA binary code 2406 (e.g., object code) that can, with or without additional linkage processing, be executed on the processor with at least one first ISA core 2416. Similarly, FIG. 24 shows the program in the high-level language 2402 may be compiled using an alternative ISA compiler 2408 to generate alternative ISA binary code 2410 that may be natively executed by a processor without a first ISA core 2414. The instruction converter 2412 is used to convert the first ISA binary code 2406 into code that may be natively executed by the processor without a first ISA core 2414. This converted code is not necessarily to be the same as the alternative ISA binary code 2410; however, the converted code will accomplish the general operation and be made up of instructions from the alternative ISA. Thus, the instruction converter 2412 represents software, firmware, hardware, or a combination thereof that, through emulation, simulation or any other process, allows a processor or other electronic device that does not have a first ISA processor or core to execute the first ISA binary code 2406.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

1. An apparatus comprising:
a hardware processor core to implement:
a trust domain manager to manage one or more hardware isolated virtual machines as a respective trust domain with a region of memory protected by a respective encryption key, and
a virtual machine monitor that is not allowed access to the protected region of memory of the one or more hardware isolated virtual machines; and
a memory management circuit coupled between the hardware processor core and the memory,
wherein, in response to a hardware isolated virtual machine generating a memory dump file, the trust domain manager is to encrypt the memory dump file with a debug key that is different from any of the respective encryption key to generate an encrypted memory dump file, and store the encrypted memory dump file in a portion of the memory that is accessible by the virtual machine monitor.

2. The apparatus of claim 1, wherein the trust domain manager is to, in response to a request to create the hardware isolated virtual machine, generate the debug key and store the debug key into a data structure of the trust domain manager.

3. The apparatus of claim 2, wherein the data structure of the trust domain manager comprises a corresponding debug key to hardware isolated virtual machine mapping for each of a plurality of hardware isolated virtual machines.

4. The apparatus of claim 2, wherein the trust domain manager is to remove the debug key from the data structure of the trust domain manager in response to a request to destroy the hardware isolated virtual machine.

5. The apparatus of claim 1, wherein the trust domain manager is to, in response to the hardware isolated virtual machine generating the memory dump file:
check, in a data structure comprising a debug key to hardware isolated virtual machine mapping, if the debug key exists for the hardware isolated virtual machine generating the memory dump file;
if the debug key exists in the data structure, encrypt the memory dump file with the debug key and store the encrypted memory dump file in the portion of the memory that is accessible by the virtual machine monitor; and
if the debug key does not exist in the data structure, return an indication of an error.

6. The apparatus of claim 1, wherein the trust domain manager is to, in response to a request to create the hardware isolated virtual machine, generate the debug key and store the debug key into a data structure of the trust domain manager when the hardware processor core is in a production mode.

7. The apparatus of claim 1, wherein the trust domain manager is to allow access to the debug key only by the trust domain manager and the hardware isolated virtual machine generating the memory dump file.

8. The apparatus of claim 1, wherein the hardware isolated virtual machine is to generate the memory dump file in response to a non-operating system application in the hardware isolated virtual machine crashing.

9. A method comprising:
managing one or more hardware isolated virtual machines as a respective trust domain with a region of memory, protected by a respective encryption key, by a trust domain manager of a hardware processor core that also comprises a virtual machine monitor that is not allowed access to the protected region of memory of the one or more hardware isolated virtual machines;
encrypting a memory dump file, by the trust domain manager in response to a hardware isolated virtual machine generating the memory dump file, with a debug key that is different from any of the respective encryption key to generate an encrypted memory dump file; and
storing the encrypted memory dump file in a portion of the memory that is accessible by the virtual machine monitor.

10. The method of claim 9, further comprising:
generating, by the trust domain manager in response to a request to create the hardware isolated virtual machine, the debug key; and
storing the debug key into a data structure of the trust domain manager.

11. The method of claim 10, wherein the data structure of the trust domain manager comprises a corresponding debug key to hardware isolated virtual machine mapping for each of a plurality of hardware isolated virtual machines.

12. The method of claim 10, further comprising removing, by the trust domain manager, the debug key from the data structure of the trust domain manager in response to a request to destroy the hardware isolated virtual machine.

13. The method of claim 9, further comprising, in response to the hardware isolated virtual machine generating the memory dump file, the trust domain manager:
checking, in a data structure comprising a debug key to hardware isolated virtual machine mapping, if the debug key exists for the hardware isolated virtual machine generating the memory dump file;
if the debug key exists in the data structure, encrypting the memory dump file with the debug key and store the encrypted memory dump file in the portion of the memory that is accessible by the virtual machine monitor; and
if the debug key does not exist in the data structure, returning an indication of an error.

14. The method of claim 9, further comprising:
generating, by the trust domain manager in response to a request to create the hardware isolated virtual machine, the debug key; and
storing the debug key into a data structure of the trust domain manager when the hardware processor core is in a production mode.

15. The method of claim 9, further comprising only allowing, by the trust domain manager, access to the debug key by the trust domain manager and the hardware isolated virtual machine generating the memory dump file.

16. The method of claim 9, further comprising generating, by the hardware isolated virtual machine, the memory dump file in response to a non-operating system application in the hardware isolated virtual machine crashing.

17. An apparatus comprising:
a memory;
a hardware processor core to implement:
a trust domain manager to manage one or more hardware isolated virtual machines as a respective trust domain with a region of memory protected by a respective encryption key, and
a virtual machine monitor that is not allowed access to the protected region of memory of the one or more hardware isolated virtual machines; and
a memory management circuit coupled between the hardware processor core and the memory,
wherein, in response to a hardware isolated virtual machine generating a memory dump file, the trust domain manager is to encrypt the memory dump file with a debug key that is different from any of the respective encryption key to generate an encrypted memory dump file, and store the encrypted memory dump file in a portion of the memory that is accessible by the virtual machine monitor.

18. The apparatus of claim 17, wherein the trust domain manager is to, in response to a request to create the hardware isolated virtual machine, generate the debug key and store the debug key into a data structure of the trust domain manager.

19. The apparatus of claim 18, wherein the data structure of the trust domain manager comprises a corresponding debug key to hardware isolated virtual machine mapping for each of a plurality of hardware isolated virtual machines.

20. The apparatus of claim 18, wherein the trust domain manager is to remove the debug key from the data structure of the trust domain manager in response to a request to destroy the hardware isolated virtual machine.

21-24. (canceled)
